(19) United States
(12) Patent Application Publication
(10) Pub. No.: US 2018/0006280 A1
(43) Pub. Date: Jan. 4, 2018

(54) CONTAINMENT SYSTEM FOR BATTERY MODULES

(71) Applicant: Eos Energy Storage, LLC, Edison, NJ (US)

(72) Inventors: Neil Ovadia, Edison, NJ (US); George W. Adamson, Edison, NJ (US)

(21) Appl. No.: 15/540,269

(22) PCT Filed: Jan. 6, 2016
(86) PCT No.: PCT/US2016/012274

§ 371 Date: Jun. 28, 2017

Related U.S. Application Data
(60) Provisional application No. 62/100,662, filed on Jan. 7, 2015.

(51) Int. Cl. H01M 2/10; B65D 25/04; B65D 19/02; B65D 81/02; B65D 85/30; B65D 21/02; B65D 25/10

(52) U.S. Cl. CPC H01M 2/1077; B65D 21/0213; B65D 25/04; B65D 25/107; B65D 81/02; B65D 85/30; B65D 19/02; B65D 2519/00786; B65D 2519/0082; B65D 2519/0086; B65D 2519/00975; H01M 2220/10; B65D 2519/00537

(57) ABSTRACT

An apparatus for storing one or more battery modules (100) comprising a containment tray (300, 500, 700, 1000) defined by opposing front and back faces (314, 316, 714, 716, 1014, 1016), opposing side faces (318, 718, 1018), and opposing top and bottom surfaces (310, 312, 522, 532, 710, 712 1010, 1011, 1012) oriented perpendicular to the front, back, and side faces, wherein the containment tray has a receiving area (302, 518, 702, 1002) formed in the top surface for receiving one or more battery modules, the receiving area comprising a receiving surface (320, 520, 720, 1020) oriented parallel to and located between the opposing top and bottom surfaces for supporting the one or more battery modules.

### CROSS REFERENCE TO RELATED APPLICATION

This PCT application claims the benefit of U.S. provisional application No. 62/100,662, filed on Jan. 7, 2015. This document is incorporated herein by reference in its entirety.

### TECHNICAL FIELD

This invention relates to containment trays and containment systems for aligning, storing, and transporting battery modules that are formed from one or more electrochemical cells.

### BACKGROUND

Electrolyte batteries, such as zinc-halide batteries (e.g., zinc-bromine batteries, zinc-chlorine batteries, and the like), offer a potential to overcome limitations associated with commonly used lead-acid batteries. In particular, the useful lifetime of zinc-halide batteries is not affected by deep discharge applications, and the energy to weight ratio of zinc-halide batteries is up to six times higher than that of lead-acid batteries.

Batteries may be stored on battery racks where the batteries serve to power electrical devices. Alternatively, batteries may be stored on battery racks where the batteries serve to discharge energy into the grid or recharge from energy sources such as the grid, wind turbine, or solar cell. These batteries typically contain a liquid electrolyte that may leak or spill onto other batteries, cables, equipment and other devices as well as personnel, thereby posing a hazard to people and property. Moreover, during transportation, batteries can be jostled or jarred to collide with one another or the walls of a container, which may damage the batteries and result in leakage or spillage of electrolyte. Additionally, large batteries and battery racks can be too heavy for people to transport without the assistance of a machine such as a forklift.

### SUMMARY OF THE INVENTION

The present invention provides containment trays and containment systems that are useful for aligning, storing, and transporting one or more battery modules that comprise one or more electrochemical cells.

In one aspect, the present invention provides an apparatus for storing one or more battery modules comprising a containment tray defined by opposing front and back faces, opposing side faces, and opposing top and bottom surfaces oriented perpendicular to the front, back, and side faces, wherein the containment tray has a receiving area formed in the top surface for receiving one or more battery modules, the receiving area comprising a receiving surface oriented parallel to and located between the opposing top and bottom surfaces for supporting the one or more battery modules.

In some embodiments, the front and back faces are oriented in parallel and separated by a distance that defines a width of the containment tray, the side faces are oriented perpendicular to the front and back faces and separated by a distance that defines a length of the containment tray, and the top and bottom surfaces are separated by a distance that defines a height of the containment tray.

In some embodiments, the receiving area is defined by a receiving front wall oriented parallel to and inward from the front face; a receiving back wall oriented parallel to and inward from the back face, the receiving front wall and back wall separated by a distance to define a length of the receiving area; a pair of receiving side walls oriented parallel to and inward from associated ones of the side faces, the pair of receiving side walls separated by a distance to define a width of the receiving area; and the receiving surface oriented perpendicular to the receiving front wall, the receiving back wall, and the pair of receiving side walls, the receiving surface separated from the top surface by a distance to define a depth of the receiving area.

In some embodiments, the depth of the receiving area is greater than a height of the one or more battery modules.

In some embodiments, the depth of the receiving area is substantially equal to a height of the one or more battery modules.

In some embodiments, the depth of the receiving area is less than a height of the one or more battery modules.

In some embodiments, a plurality of side wall spacers that protrude inward from each of the pair of receiving side walls, each side wall spacer comprising a side contact surface for contacting at least a first surface of the one or more battery modules adjacent to the receiving side walls; and a plurality of front-back wall spacers protruding inward from the receiving front wall or the receiving back wall, each front-back wall spacer comprising a contact surface for contacting at least a second surface of the one or more battery modules adjacent to the receiving front wall or the receiving back wall.

In some embodiments, one or more divider walls are disposed within the receiving area and extending between the receiving front wall and the receiving back wall, the one or more divider walls oriented in parallel with respect to the receiving side walls and configured to divide the receiving area into substantially equally spaced rows each having a substantially uniform width.

In some embodiments, one or more sets of dividers are disposed within the receiving area and extend between the receiving side walls, each set of dividers oriented in parallel with respect to the receiving front wall and the receiving back wall and configured to divide the receiving area into equally spaced columns each having a uniform width, wherein the sets of the dividers and the one or more divider walls are configured to segment the receiving area into a plurality of receiving compartments each separated from one another and configured to accommodate the one or more battery modules.

In some embodiments, a plurality of divider wall spacers protrude outward from one or more surfaces of the one or more divider walls toward the opposing receiving side walls, each divider wall spacer comprising a surface for contacting one or more surfaces of the one or more battery modules adjacent to the one or more divider walls.

In some embodiments, one or more of the divider walls extend between the receiving sidewalls, the divider walls oriented in parallel with respect to the front wall and the back wall and configured to divide the receiving area into substantially equally spaced columns each having a uniform length, wherein the one or more divider walls extending between the receiving sidewalls and the one or more divider walls extending between the front wall and the back wall are configured to segment the receiving area into a plurality of receiving compartments each separated from one another and configured to accommodate the one or more battery modules.

In some embodiments, a plurality of ribs protruding from the receiving surface to provide a spacer between the one or more battery modules and the receiving surface.

In some embodiments, the bottom surface of the containment tray rests upon a ground surface.

In some embodiments, the containment tray is stacked upon a top surface of another containment tray and provides a cover for one or more battery modules within the receiving area of the other containment tray underneath.

In some embodiments, the top surface of the containment tray is configured to support at least a portion of a lid for covering the one or more battery modules within the receiving area.

In some embodiments, the containment tray further comprises one or more openings extending through the front and back faces or one or more openings extending through opposing side faces. In some embodiments, the openings are fork openings configured to receive forks from a forklift.

In some embodiments, the containment tray further comprises one or more conduit terminals for connecting the one or more battery modules to one another. In some embodiments, the containment tray further comprises one or more conduit terminals for connecting the one or more battery modules to an electronic device.

In some embodiments, the containment tray further comprises a flame retardant material. In some embodiments, the flame retardant material comprises at least one of high-density polyethylene or polypropylene.

In another aspect, a containment system of the present invention comprises two or more containment trays stacked in a parallel orientation to form a stack, each containment tray comprising: opposing front and back faces, opposing side faces, and opposing top and bottom surfaces, wherein the opposing top and bottom surfaces are oriented perpendicular to the opposing front and back faces and the opposing side faces; and a receiving area on the top surface for receiving one or more battery modules, the receiving area comprising a receiving surface oriented parallel to and located between the opposing top and bottom surfaces for supporting the one or more battery modules.

In some embodiments, one or more containment lids are each oriented parallel to the two or more containment trays and configured to cover the one or more battery modules within the receiving areas of the containment trays, the containment lids and the two or more containment trays stacked in an alternating repeating pattern.

In some embodiments, at least one of the two or more containment trays includes one or more openings. In some embodiments, the one or more openings are slots for receiving forks from a forklift.

In some embodiments, a base rests upon a ground surface and is configured to support the bottom surface of the containment tray at the bottom of the stack.

In some embodiments, one or more conduit terminals are disposed at one or more of the containment trays for connecting the one or more battery modules to one another. In some embodiments, one or more conduit terminals are disposed at one or more of the containment trays for connecting the one or more battery modules to an electronic device.

### DESCRIPTION OF DRAWINGS

The following figures are provided by way of example and are not intended to limit the scope of the invention.

FIG. 1 is a perspective view of a battery module in accordance with one or more embodiments of the present invention.

FIG. 2 is a perspective view of an example containment system for battery modules in accordance with one or more embodiments of the present invention.

FIGS. 3A and 3B are perspective (FIG. 3A) and top (FIG. 3B) views of a tray of the containment system of FIG. 2 in accordance with one or more embodiments of the present invention.

FIGS. 4A and 4B are perspective (FIG. 4A) and exploded (FIG. 4B) views of a containment system for battery modules in accordance with one or more embodiments of the present invention.

FIGS. 5A and 5B are exploded (FIG. 5A) and perspective (FIG. 5B) views of a containment system for battery modules in accordance with one or more embodiments of the present invention.

FIG. 6A is an exploded view of a containment system for battery modules in accordance with one or more embodiments of the present invention.

FIG. 6B is a top view of a tray of the containment system of FIG. 6A in accordance with one or more embodiments of the present invention.

FIG. 6C is a side view of a tray of the containment system of FIG. 6A in accordance with one or more embodiments of the present invention.

FIG. 6D is a side view of a lid of the containment system of FIG. 6A in accordance with one or more embodiments of the present invention.

FIG. 6E is a bottom view of a tray of the containment system of FIG. 6A in accordance with one or more embodiments of the present invention.

FIGS. 6F and 6G are cross-sectional views taken along lines 6F-6F (FIG. 6F) and 6G-6G (FIG. 6G) showing the containment system including a plurality of containment trays and containment lids stacked in an alternating repeating pattern.

Like reference symbols in the various drawings indicate like elements.

### DETAILED DESCRIPTION

The present invention provides containment trays and containment systems that are useful for aligning, storing, and transporting one or more battery modules that comprise one or more electrochemical cells.

### I. Definitions

As used herein, the terms “battery module” and “battery” are used interchangeably to refer to an energy storage device comprising one or more electrochemical cells. A “secondary battery” is rechargeable, whereas a “primary battery” is not rechargeable. For secondary batteries of the present invention, a battery anode is designated as the positive electrode during discharge, and the negative electrode during charge.

As used herein, the term “electrochemical cell” and “cell” are used interchangeably to refer to a galvanic cell. Examples of electrochemical cells include, without limitation, zinc halide cells.

As used herein, an “electrolyte” refers to a substance that behaves as an electrically conductive medium. For example, the electrolyte facilitates the mobilization of electrons and cations in the cell. Electrolytes include mixtures of materials such as aqueous solutions of zinc halide or other zinc and halide containing materials. Some electrolytes also comprise additives such as buffers. For example, an electrolyte comprises a buffer comprising a borate or a phosphate.

As used herein, the term “polyethylene” and its abbreviation “PE” are used interchangeably to refer to a polymer material that comprises polyethylene. Use of the term polyethylene or initials in no way implies the absence of other constituents. This term also encompasses substituted polyethylene and co-polymers thereof (e.g., block and alternating co-polymers). In some instances, high-density polyethylene is any polyethylene having a density of greater than or equal to 0.94 g/cm². In other instances, low-density polyethylene is any polyethylene having a density of less than 0.94 g/cm².

As used herein, the term “Flame Retardant High-Density Polyethylene” and its corresponding initials “FR HDPE” are used interchangeably to refer to any high-density polyethylene that is treated to resist fire or combustion, including, without limitation, fire rated high-density polyethylene and fire retardant high-density polyethylene. Other examples of ‘FR HDPE’ include high-density polyethylene that is coated or otherwise combined with a flame-retarding agent (e.g., a fire resistant epoxy resin binder, a phosphorous compound, a bromine compound, antimony trioxide, or any combination thereof).

As used herein, the term “polypropylene” and its abbreviation “PP” are used interchangeably to refer to a polymer material comprising polypropylene. Use of the term polypropylene or initials in no way implies the absence of other constituents. This term also encompass substituted polymers, and co-polymers (e.g., block and alternating co-polymers).

As used herein, an “anode” is a negative electrode from which electrons flow during the discharging phase of the cell. The anode is also the electrode or material that undergoes chemical oxidation during the discharging phase. However, in secondary, or rechargeable, cells, the anode is the electrode or material that undergoes chemical reduction during the cell's charging phase. Anodes are formed from electrically conductive or semiconductive materials, e.g., metals, metal oxides, metal alloys, metal composites, semiconductors, or the like. Anode materials such as zinc may even be sintered. In zinc halide cells, zinc is the anode material that undergoes oxidation upon discharge of the cell.

As used herein, a “cathode” is a positive electrode from which electrons flow during the discharging phase of the battery. The cathode is also the electrode or material that undergoes chemical reduction during the discharging phase. However, in secondary, or rechargeable, cells, the cathode is the electrode or material that undergoes chemical oxidation during the cell's charging phase. Cathodes are formed from electrically conductive or semiconductive materials, e.g., metals, metal oxides, metal alloys, metal composites, semiconductors, or the like. Common cathode materials include, without limitation, halide ions. For example, in zinc halide cells, halide (X⁻), wherein X is a halogen atom, is the cathode material that undergoes oxidation upon discharge of the cell.

As used herein, the term “electronic device” is any device that is powered by electricity.

As used herein, the terms “containment tray”, “tray”, and “container” are used interchangeably to refer to a structure that is configured to align and store one or more battery modules. In some examples, the tray comprises a receiving area for aligning and storing one or more battery modules. In other examples, the receiving area may be divided into one or more receiving compartments, each receiving compartment storing an associated battery module. The receiving area may include front, back, and sidewalls enclosing at least a portion of the sides of the battery modules.

As used herein, the terms “cover”, “lid”, and “containment lid” are used interchangeably to refer to a structure that at least partially encloses a top surface of one or more battery modules stored within a receiving area of a containment tray. The cover or lid may include a hollowed portion having a depth for enclosing a portion of battery module sides.

As used herein, the term “containment system” refers to a plurality of containment trays and at least one cover. In some embodiments, the containment system comprises containment trays that are stacked on top of each other and the topmost tray is at least partially covered by a lid. In other embodiments, the system comprises containment trays and containment lids stacked in an alternating repeating pattern. For example, a bottom first containment tray may rest on a ground surface, a containment cover may stack on top of the bottom containment tray, and a second containment tray may stack on top of the containment cover. Faces of the containment trays or containment covers may include conduit terminals configured to connect the one or more battery modules in series or in parallel and for connecting the one or more battery modules to an electronic device or power grid.

### II. Battery Module

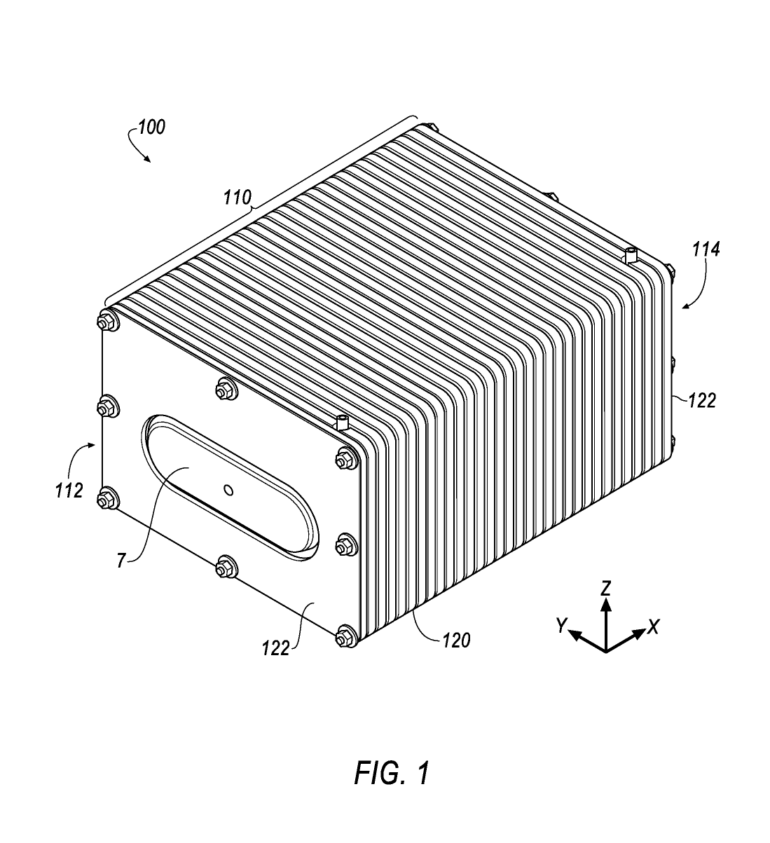

Referring to FIG. 1, in some embodiments, a battery module 100 comprises a plurality of intermediate cells 110 arranged in a parallel orientation along an x-axis between a terminal anode assembly 112 and a terminal cathode assembly 114. The battery module includes a width extending parallel with respect to a y-axis perpendicular to the x-axis and a height extending parallel with respect to a z-axis perpendicular to the x- and y-axis. In some embodiments, the battery module comprises one or more rechargeable electrochemical cells, wherein the one or more cells comprises an electrolyte that is a liquid at operational temperatures (e.g., from about 20° F. to about 200° F.). For example, the battery module comprises one or more zinc-halide cells comprising an aqueous zinc-halide electrolyte. In some embodiments, the battery module comprises one or more rechargeable zinc-bromine cells comprising an aqueous zinc-bromide electrolyte. In other embodiments, the intermediate cells may comprise bipolar electrodes for distributing current between the terminal anode and cathode assemblies. In some embodiments, each cell of the battery module comprises a frame 120 that houses components of the cell. In addition, in some embodiments, each end of the battery module comprises a puck 7 and a corresponding pressure plate 122 for retaining the cells. The pressure plates are disposed at each end of the battery module. A puck is electrically coupled to each of the battery's terminal electrodes (e.g., terminal anode and cathode assemblies). The pucks provide a means through which current may enter and leave the battery module. Each terminal electrode is capable of collecting current from, and distributing current to, the electrochemical cells of the battery module.

### III. Containment Systems for Battery Modules

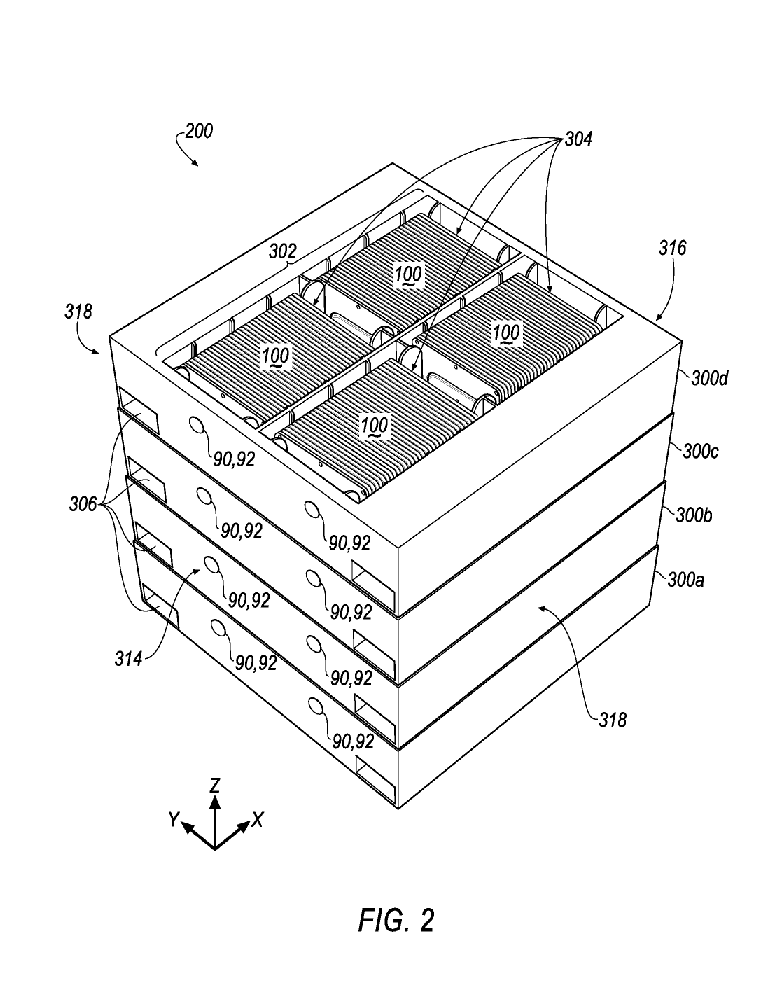

Exemplary containment systems 200, 400, 600, 900 are depicted in FIGS. 2-6G for aligning, storing, and transporting one or more battery modules. The containment systems comprise stacked containment trays 300a-300d, 500a-500d, 700a-700b, 1000a-1000b. The containment trays are useful for positioning or aligning one or more battery modules to facilitate the electrical communication between battery modules that are received in different containment trays. For example, when the containment trays are stacked to form a containment system or a portion of a containment system, the containment trays are configured to receive one or more battery modules that substantially align, e.g., vertically align, with one or more battery modules received in containment trays above or below the battery module. Moreover, the containment trays operate to stabilize the battery modules during transportation by receiving or nesting the battery module and restricting the battery module's ability to collide with other battery modules or walls of a container during the jarring or jostling motions that are common during transportation.

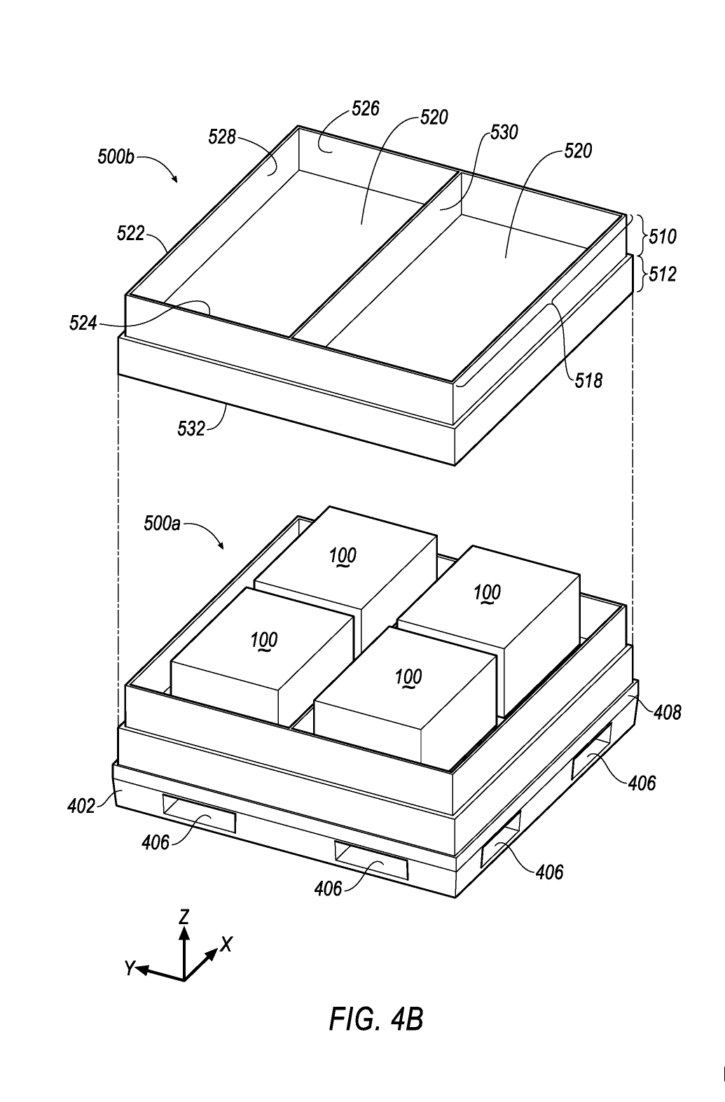

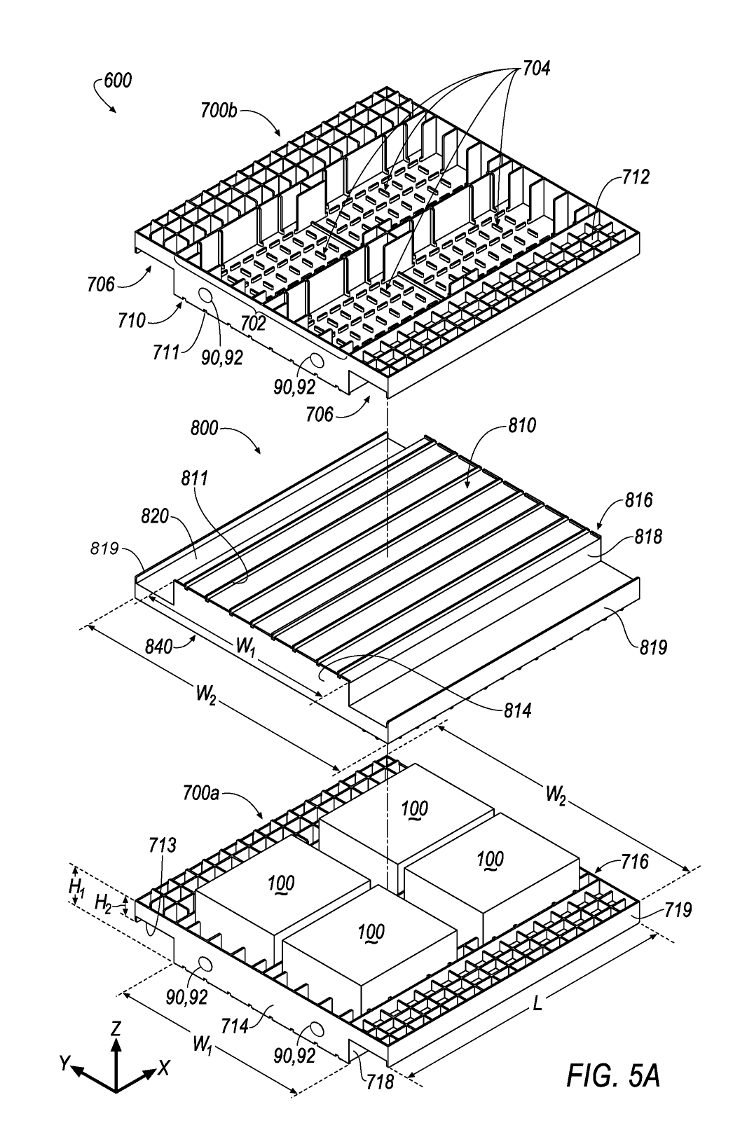

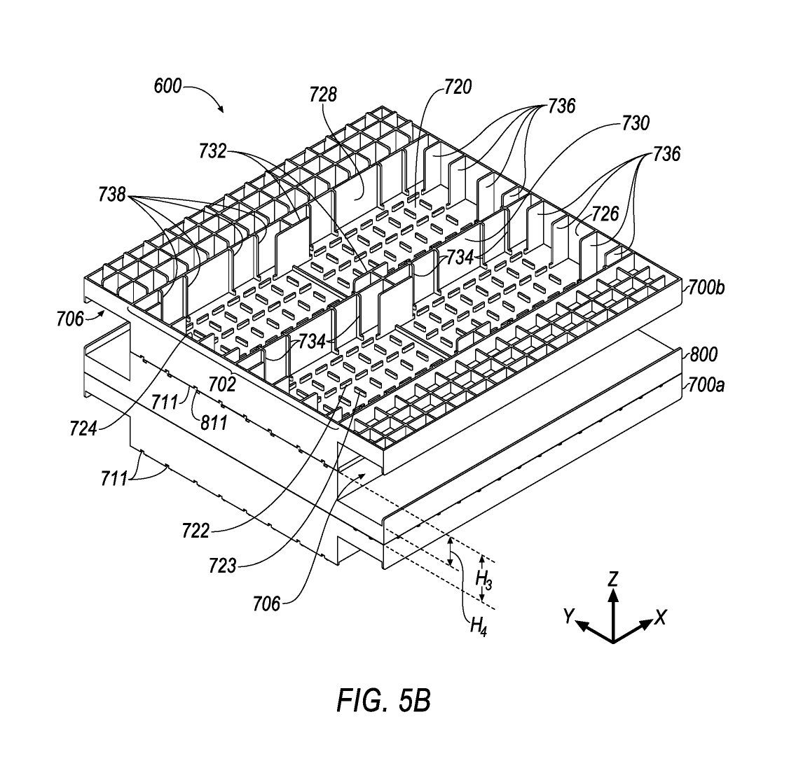

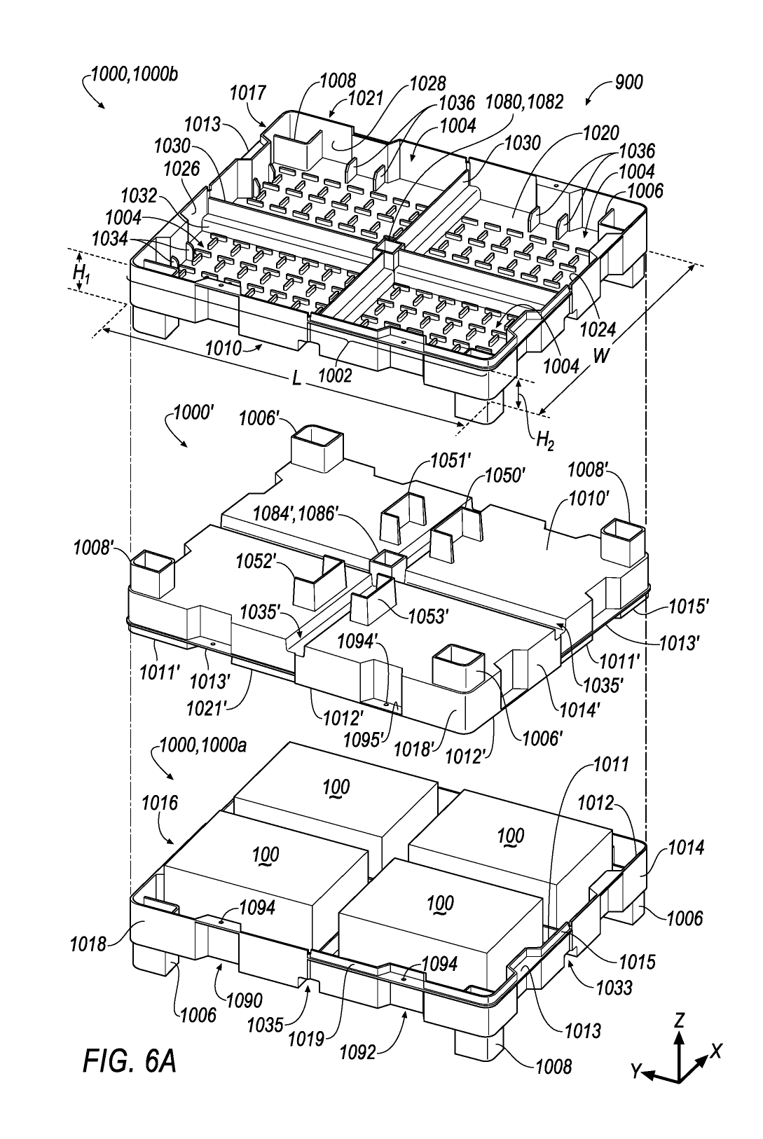

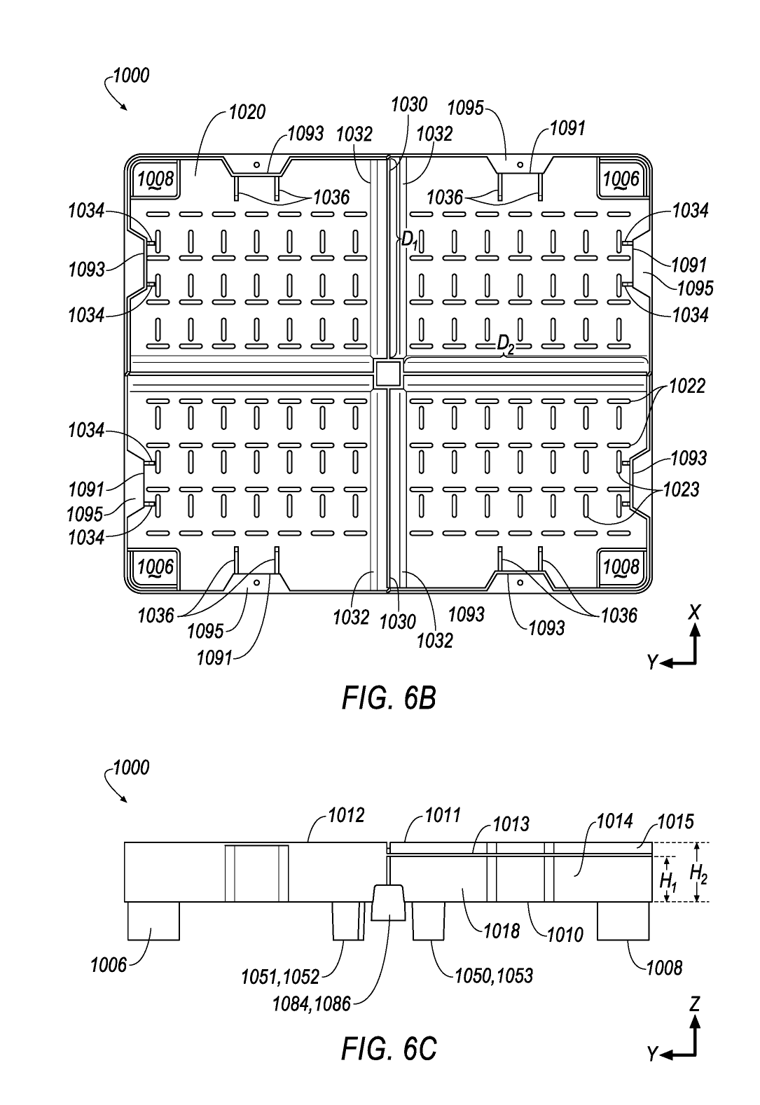

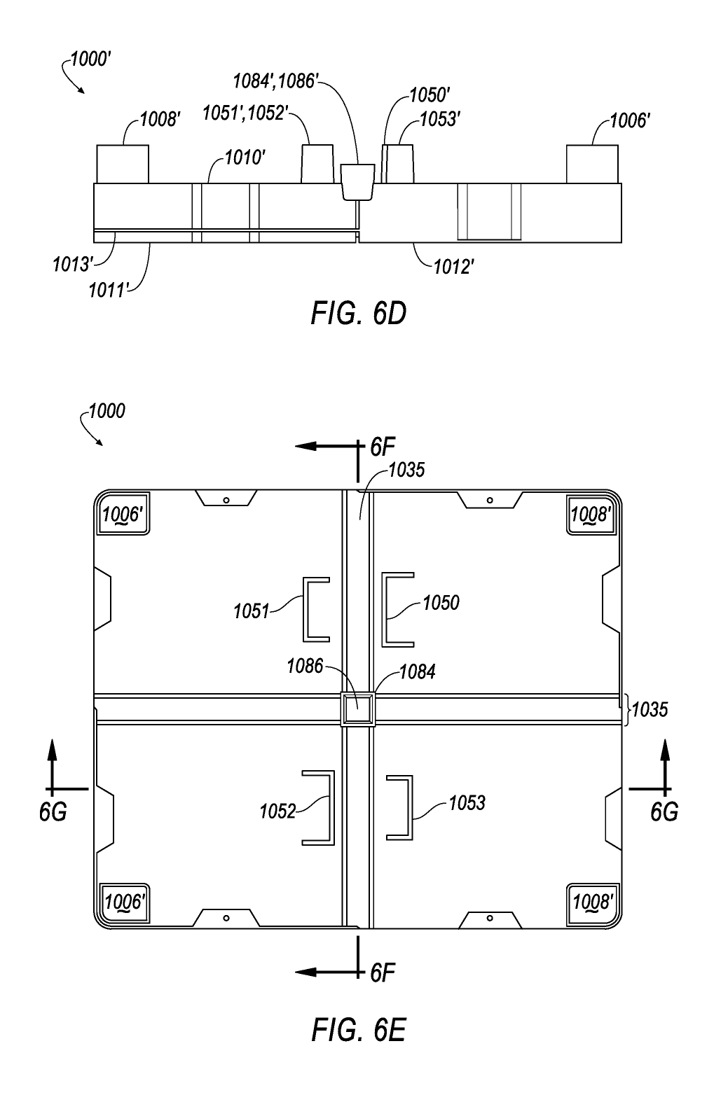

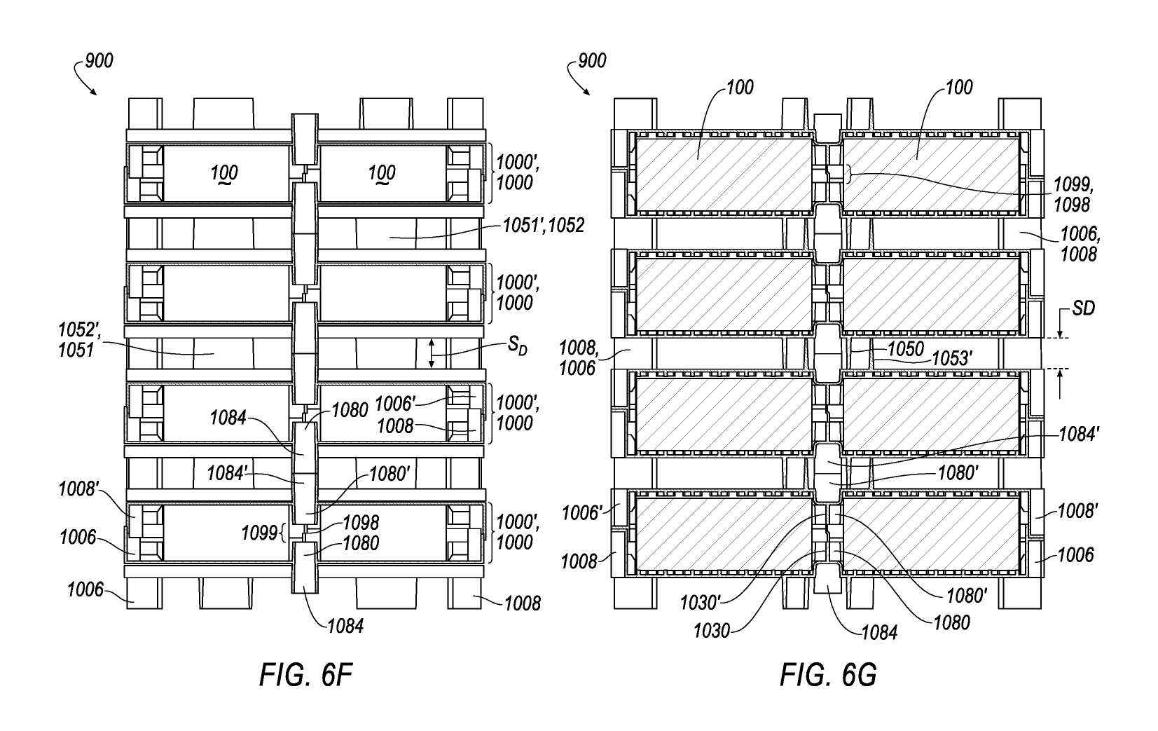

The containment trays of the present invention comprise a receiving area for enclosing at least a portion of sides of a battery module received therein. In some embodiments, the containment trays 300, 500 (FIGS. 2-4B) are additionally configured to at least partially cover or enclose top surfaces of battery modules 100 that are enclosed within a containment tray 300, 500 underneath, for example, when containment trays are vertically stacked. In other embodiments, the containment systems 600, 900 (FIGS. 5A-6G) comprise a containment lids 800, 1000′ disposed between each containment tray 700, 1000 of the containment system 600, 900. In some embodiments, the containment system comprises a lid that at least partially covers the top surface of a topmost containment tray.

In some embodiments, the containment trays 300, 500, 700, 1000 and containment lids 800, 1000′ comprise non-conductive materials such as FR HDPE and polypropylene materials. FR HDPE and PP materials are commonly recyclable and each provide an improved strength to density ratio (e.g., from 0.80 to 0.99 g/cm³) and can withstand high temperatures (e.g., from about 110° C. to about 180° C.) before melting or undergoing structural failure.

In some embodiments, the containment system comprises one or more conduit terminals such as holes 90, snap-in-connectors 92, or gaps 1099 (e.g., as shown in FIGS. 2, 4A, 5A, 6F, and 6G) for connecting the battery modules to each other as well as connecting the one or more battery modules to an electronic device, grid, or energy source. In some embodiments, front and back faces of the containment trays each comprise one or more conduit terminals. In other embodiments, opposing side faces of the containment trays each comprise one or more conduit terminals. Wires or cables may connect to the battery modules and the electronic device, grid, or energy source via the conduit terminals. In some embodiments, the battery modules received within the containment trays are electrically connected in series. In other embodiments, the battery modules received within the containment trays are electrically connected in parallel. In other embodiments, the some battery modules in the system are connected in parallel while other battery modules of the system are connected in series.

Referring to FIG. 2, a perspective view of an example containment system 200 for one or more battery modules 100 is shown. The containment system includes one or more containment trays 300a-300d each configured to store one or more battery modules within a receiving area 302. The receiving area 302 may be divided into receiving compartments 304, wherein each receiving compartment is configured to receive a battery module. In the example shown, each receiving area is divided into four receiving compartments for receiving four battery modules. The trays are stacked on top of one another in a parallel orientation with respect to the z-axis to define at least a portion of the height of the containment system. Front and back faces 314, 316, respectively, are oriented in parallel with respect to the y-z plane to define a width of the trays while side faces 318 are oriented in parallel with respect to the x-z plane to define a length of the trays. In some embodiments, the tray comprises one or more openings 306 configured to engage with a machine (e.g., a forklift, crane, or the like) for lifting, stacking, securing, and/or transporting the tray. In some examples, the front and back faces of the tray, the side faces of the tray, or any combination thereof further comprise one or more openings configured to engage with a machine (e.g., a forklift, crane, or the like) for lifting, stacking, securing, and/or transporting the tray. In other examples, the tray comprises at least two openings configured to receive forks from a forklift for lifting, stacking, securing, and/or transporting the tray. For instance, the front and back faces of the tray, the side faces of the tray, or any combination thereof may further comprise at least two openings configured to receive forks from a forklift for lifting, stacking, securing, and/or transporting the tray. A forklift may further lift and transport the entire containment system by inserting its forks into the openings of the bottom stack 300a. In the example shown, the openings extend through each tray between the front and back faces. In other embodiments, the openings extend through each tray between the side faces. In addition, in some embodiments, each tray comprises four fork openings, wherein two fork openings extend through the trays between the front and back faces, and the remaining two fork openings extend through the tray between the side faces.

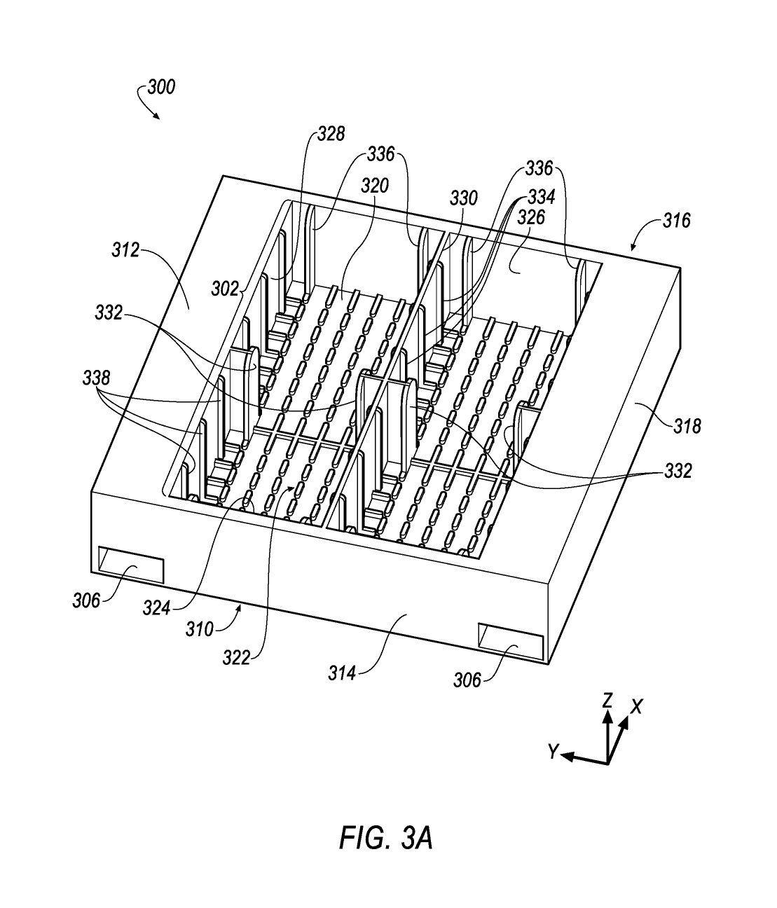

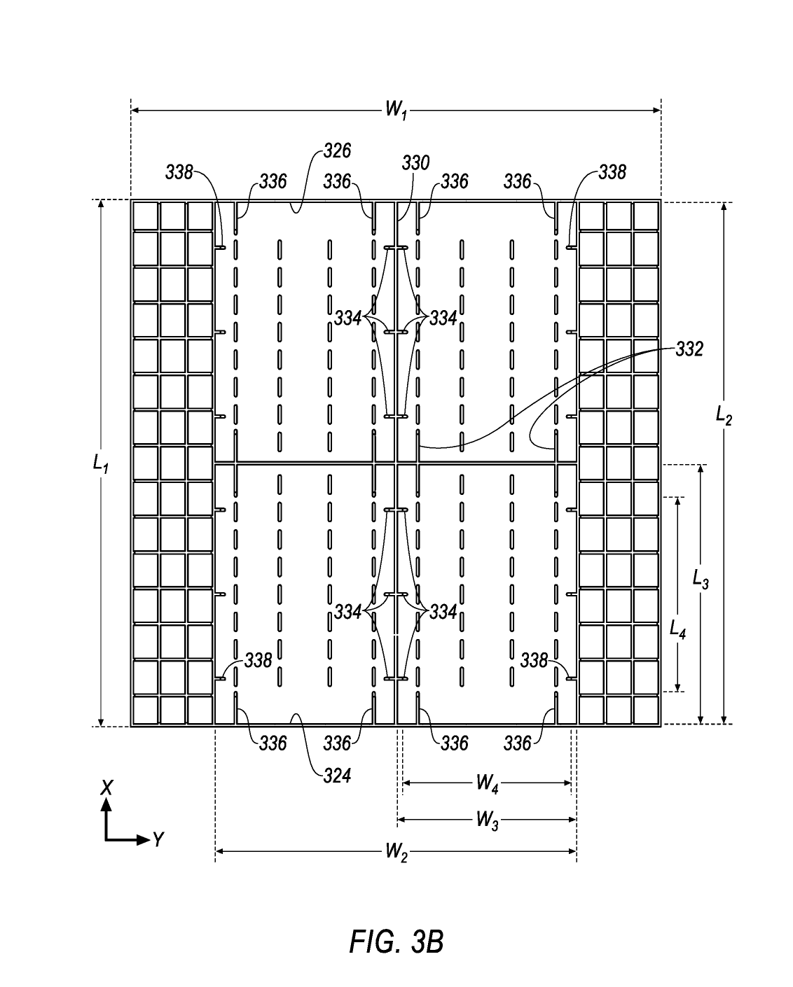

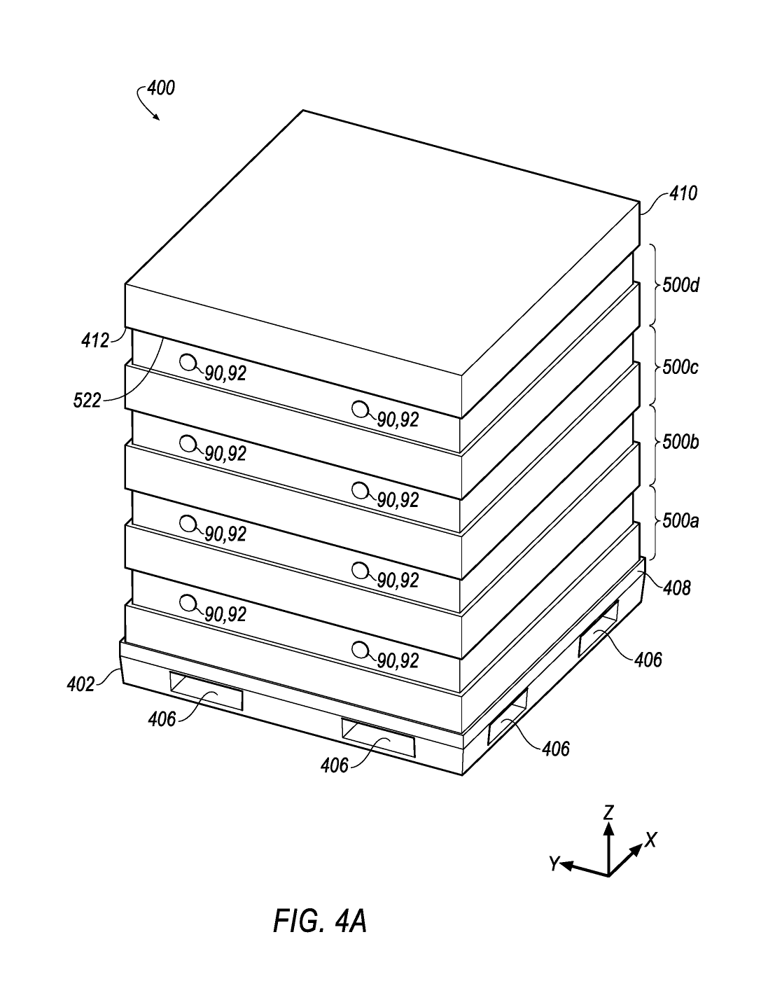

Referring to FIGS. 3A and 3B, perspective (FIG. 3A) and top (FIG. 3B) views of an example tray 300 of the containment system of FIG. 2 are shown. Bottom and top surfaces 310, 312, respectively, are parallel to the x-y plane and are separated by a distance that defines the height of the tray. The bottom and top surfaces include a length L₁ and a width W₂. In some examples, L₁ and W₁ are equal. In other examples, L₁ can be less than or greater than W₁. In some implementations, the bottom surface 310 of the bottom tray 300a may rest against the ground surface. In other implementations, when the tray is stacked on top of another tray (e.g., tray 300b stacked on top of tray 300a), the bottom surface 310 of the top tray 300b is supported by the top surface 312 of the bottom tray 300a to provide a cover or lid for the battery modules within the receiving area 302 of the bottom tray 300a. In some embodiments, a lid (e.g., lid 410 of FIG. 4) may engage with the top containment tray 300d for covering the battery modules 100 stored therein. In some embodiments, the lid is welded onto the top surface 312 of the top containment tray 300d of the stack. In other embodiments, the lid is fastened to the top surface using one or more fasteners (e.g., snaps, bolts, or the like).

The receiving area 302 is formed in the top surface 312 of the tray 300 and is defined by a receiving front wall 324, a receiving back wall 326 and receiving sidewalls 328. The receiving front and back walls are oriented in parallel with respect to the y-z plane and separated by a distance L₂ while the receiving sidewalls 328 are oriented in parallel with respect to the x-z plane and separated by a distance W₂. In the example shown, L₂ is greater than W₂. However, in other examples, W₂ is greater than L₂, W₂ is equal to L₂, or W₂ is less than L₂. The receiving area includes a receiving surface 320 parallel to the x-y plane. A distance between the receiving surface and the top surface defines a height of the walls 324, 326, 328 and denotes a depth of the receiving area 302. In some examples, the receiving area depth is selected based on the height of the battery modules being received therein. For example, the receiving area depth may be greater than the height of the battery modules being received therein. In other examples, the receiving area depth may be less than or equal to the height of the battery modules being received therein. The receiving surface is configured to support the battery modules received by the receiving area.

In some embodiments, the receiving area optionally comprises a plurality of ribs 322 that protrude from the receiving surface to provide space between resting surfaces of the received battery module and the receiving surface. Ribs can be configured to have any shape. In some embodiments, the receiving area comprises a plurality of ribs, wherein the distance from the receiving surface and the top of the rib extending therefrom is substantially the same (e.g., ±1 mm, ±0.75 mm, ±0.5 mm, or ±0.25 mm). In one example, the ribs are configured such that if one of the battery modules leaks, the leaked electrolyte may be contained along the receiving surface without contacting the resting surfaces of the battery modules within the receiving area. The ribs may be arranged in any suitable configuration (e.g., uniformly spaced rows across the receiving surface). In the example shown, the ribs are arranged in uniformly spaced rows each oriented in parallel with respect to the x-axis. In some examples, the ribs may be arranged in two sets of uniformly spaced rows. For example, a first set may include rows oriented in parallel with respect to the x-axis while a second set may include rows oriented in parallel with respect to the y-axis.

In some examples, the receiving area comprises one or more divider walls 330 disposed therein. The divider walls 330 may be oriented in parallel with respect to the x-axis and extend between the front and back walls 324, 326, respectively. The divider walls 330 include a height associated with the receiving area 302 depth (i.e., distance between the receiving surface 320 and the top surface 302). The divider walls are configured to divide the receiving area into equally spaced rows each having a substantially uniform width with respect to the y-axis. In the example shown, one divider wall is disposed within the receiving area 302 to divide the receiving area into two equally spaced rows. As shown in FIG. 3B, the divider wall 330 is parallel to and spaced inward from the side walls 328 by a distance equal to W₃. However, other examples can include two divider walls to divide the receiving area into three equally spaced rows, three divider walls to separate the receiving area into four equally spaced rows and so on.

Additionally, the receiving area includes dividers 332 disposed therein. The dividers may be oriented parallel to or along the y-axis and extend between the sidewalls. The dividers 332 include a height associated with the divider walls and the receiving area depth. The dividers are configured to divide the receiving area into equally spaced columns having a substantially uniform length with respect to the x-axis. In the example shown, one set of four dividers 332 oriented along the y-axis divide the receiving area into two substantially equally spaced columns. As shown in FIG. 3B, the dividers are parallel to and spaced inward from the front and back walls 324, 326, by a distance of L₃. However, other examples can include two sets of dividers, wherein each divider is oriented parallel to the others and divides the receiving area into three equally spaced columns, three sets of four dividers 332 each oriented parallel to the others and divides the receiving area into four equally spaced columns and so on.

In the example shown, a pair of dividers is disposed within the first row on one side of the divider wall while another pair of dividers is disposed within the second row on the other side of the divider wall. Each divider comprises a first contact surface parallel to and facing the front wall and a second contact surface parallel to and facing the back wall. The first contact surfaces are associated with a first column of the receiving area while the second contact surfaces are associated with a second column of the receiving area. The first contact surfaces of the pair of dividers disposed within the first row are configured to contact a surface of a first battery module received within the first column of the first row between the divider wall, the back wall, and the sidewall adjacent to the first row of the receiving area. The second contact surfaces of the pair of dividers disposed within the first row are configured to contact a surface of a second battery module received within the second column of the first row between the divider wall, the front wall, and the sidewall adjacent to the first row of the receiving area 302.

Similarly, the first contact surfaces of the pair of dividers disposed within the second row are configured to contact a surface of a third battery module received within the first column of the second row between the divider wall, the back wall, and the side wall adjacent to the second row of the receiving area. The second contact surfaces of the pair of dividers disposed within the second row are configured to contact a surface of a fourth battery module 100 received within the second column of the second row between the divider wall 330, the front wall 325, and the side wall 328 adjacent to the second row of the receiving area 302.

Accordingly, the dividers and the one or more divider walls are configured to segment each of the receiving compartments of the receiving area. In some embodiments, spacers 334, 336, 338 are provided to prevent surfaces of the battery modules within each of the receiving compartments from contacting the front, back, side or divider walls 324, 326, 328, 330, respectively. For example, the divider wall 330 includes a plurality of divider wall spacers 334 that protrude outward from the divider wall 330 toward the sidewalls 328 with respect to the x-y plane. Each divider wall spacer includes a contact surface for contacting surfaces of the battery modules adjacent to the divider wall. Similarly, the sidewalls include a plurality of sidewall spacers 338 that protrude inward from the sidewalls toward the divider wall with respect to the x-y plane. Each sidewall spacer 338 includes a contact surface for contacting surfaces of the battery modules adjacent to the sidewalls. The front and back walls comprise a plurality of front-back wall spacers 336 protruding inward from the walls 324 or 326 toward the dividers 332 with respect to the x-y plane. Each front-back wall spacer includes a contact surface for contacting surfaces of the battery modules adjacent to the front wall 324 or the back wall 326. In the example shown, each receiving compartment is defined by a width W4 and a length L4. The width W4 denotes the distance between the contact surface of the sidewall spacers and the contact surface of the divider wall spacers associated with each receiving compartment. The length L4 denotes the distance between the contract surface of the front-back wall spacers and the first or second contact surfaces of the dividers associated with each receiving compartment.

Referring to FIGS. 4A and 4B, perspective (FIG. 4A) and exploded (FIG. 4B) views of another example containment system 400 for one or more battery modules is shown. The containment system comprises a base 402, a top lid 410, and one or more containment trays 500a-500d. Each tray comprises a base portion 512 and a receiving portion 510 configured to receive and store one or more battery modules. The trays 500a-500d are stacked on top of one another between the base and the lid in a parallel orientation with respect to the z-axis to define a height of the containment system. The base of the containment system rests on a ground surface (e.g., parallel to the x-y plane) and comprises one or more openings configured to engage with a machine (e.g., a forklift, crane, or the like) for lifting, stacking, securing, and/or transporting the tray. In some embodiments, the base comprises at least two fork openings 406 configured to receive forks from a forklift that can lift the base 402 and any trays 500 stacked on top of the base 402. Accordingly, a forklift may lift and transport the entire containment system 400 by inserting the forks into the fork openings 406 extending through the base 402.

A top surface of the base is oriented in parallel with respect to the x-y plane and is configured to support the base portion of the bottom tray 500a when stacked thereon. In some examples, a lip 408 extends upward from the perimeter of the top portion of the base. The lip may enclose the outer perimeter of the base portion of the bottommost tray 500a to assist in aligning and securing the bottommost tray on top of the base. However, the base portions of trays 500b-500d stacked on top of the bottommost tray are each configured to cover the battery modules stored at the receiving portion 510 of the associated tray underneath. The top lid of the containment system is configured to cover the battery modules stored at the receiving portion of the topmost tray 500d. A bottom perimeter surface 412 of the top lid 410 rests along a top perimeter surface 522 of the receiving portion 510 of the topmost tray. The top and bottom perimeter surfaces are oriented in parallel with respect to the x-y plane. The top lid 410 further includes a hollowed portion inward from the bottom perimeter surface for accepting the height of the battery modules that is exposed above the receiving portion 510 of the topmost tray. For example, the top lid may be hollowed by a depth extending perpendicularly from the bottom perimeter surface. Thus, the hollowed portion of the top lid encloses portions the battery modules stored at the receiving portion of the topmost tray.

Referring to FIG. 4B, the bottom perimeter surface 532 of the base portion and the top perimeter surface 522 of the receiving portion for each tray are parallel to the x-y plane and are separated by a distance that defines a height of the tray. The bottom perimeter surface 532 may include a length with respect to the x-axis and a width with respect to the y-axis that are equal or unequal. The top perimeter surface may include a length with respect to the x-axis and a width respect to the y-axis that are equal or unequal. In the example shown, the length and width of the bottom perimeter surface is greater than the length and width of the top perimeter surface. However, in other examples, the length and width of the bottom perimeter surface may be less than or equal to the length and width of the top perimeter surface.

The receiving portion for each tray includes a receiving area 518 for receiving one or more battery modules. The receiving area is formed inward from the top perimeter surface and is defined by a receiving front wall 524, a receiving back wall 526 and receiving sidewalls 528. The receiving front and back walls are oriented in parallel with respect to the y-z plane while the receiving sidewalls 528 are oriented in parallel with respect to x-z plane. The receiving area includes a receiving surface 520 oriented in parallel with respect to the x-y plane. A distance between the receiving surface and the top perimeter surface defines a height of the walls 524, 526, 528 and denotes a depth of the receiving area. In some examples, the receiving area depth is selected based on the height of the battery modules being received therein and/or a depth of hollowed portions of the lid or base portion of a tray stacked on top. The receiving surface is configured to support the battery modules received by the receiving area 518.

In some examples, the receiving surface may include plurality of ribs protruding therefrom to provide a spacer between resting surfaces of the battery modules and the receiving surface. For example, if one of the battery modules leaks electrolyte, the leaked electrolyte may be contained along the receiving surface 520 without contacting the resting surface of other battery modules within the receiving area 518. Ribs may be arranged in any configuration along the receiving surface 520.

In some examples, one or more divider walls 530 are disposed within the receiving area. The divider walls may be oriented in parallel with respect to the x-axis and extend between the front and back walls. The divider walls may include a height associated with the receiving area depth (i.e., distance between the receiving surface 520 and the top perimeter surface 522). The divider walls are configured to divide the receiving area into equally spaced rows each having a uniform width with respect to the y-axis. In the example shown, one divider wall is disposed within the receiving area to divide the receiving area into two equally spaced rows. However, other examples can include two divider walls that divide the receiving area into three equally spaced rows, three divider walls to separate the receiving area into four equally spaced rows, and so on. In the example shown, the receiving area for each tray is configured to accommodate four battery modules.

As aforementioned, the base portion for each tray (except the bottom tray 500a) is configured to at least partially cover the battery modules stored within the receiving area of the associated tray underneath. The bottom perimeter surface 532 rests along the top perimeter surface 522 of the receiving portion 510 of the tray 500 underneath. The base portion further includes a hollowed portion inward from the bottom perimeter surface for accepting the height of the battery modules stored within the receiving area of the tray underneath. For example, the base portion may be defined by a depth extending perpendicularly from the bottom perimeter surface 532. Thus, the hollowed portions of the base portions for each of the trays 500b-500d encloses portions of the battery modules stored within the receiving area of the tray underneath.

FIGS. 5A and 5B are exploded (FIG. 5A) and perspective (FIG. 5B) views of another example containment system 600 for battery modules. The containment system comprises one or more containment trays 700a-700b each configured to store one or more battery modules within a receiving area 702. The receiving area may be divided into receiving compartments 704, wherein each receiving compartment is configured to receive a battery module. In the example shown, each receiving area is divided into four receiving compartments 704 for receiving four battery modules. The containment system further comprises one or more containment lids 800 each configured to at least substantially cover battery modules stored within the receiving area 702 of each associated tray underneath. Accordingly, the trays and the containment lids are stacked in an alternating repeating pattern and oriented in parallel with respect to the z-axis to define a height of the containment system, wherein a bottom surface 710 of the bottom tray rests against ground and each lid is disposed between two trays.

Front and back faces 714, 716 of trays 700 are oriented in parallel with respect to the y-z plane to define widths W₁ and W₂, while inner and outer side faces 718, 719, are oriented in parallel with respect to the x-z plane to define a length L₁. Each tray includes a top surface 712 and a bottom surface 710 oriented in parallel with respect to the x-y plane and separated by a height H₁ corresponding to the height of the front and back faces. The top surface 712 may be grated to provide structural support when transporting the trays 700 and to reduce weight. The bottom surface 710 is defined by the width W₁ extending between the inner side faces 718. The top surface 712 is defined by the width W₂ extending between the outer side faces 719. Fork support surfaces 713 oriented perpendicular to and extending away from the inner side faces 718 to the outer side faces 719 are configured to receive forks from a forklift for lifting the trays. In the example shown in FIG. 5A, the fork support surfaces, and the bottom surface are separated by a height H₂. Accordingly, a pair of fork slots 706 oriented in parallel with respect to the x-axis are defined by the inner side faces 718 and the fork support surfaces 713 along the length L₁ for receiving forks from the forklift for transporting the trays, stacking the trays on top of the containment lids, and/or removing trays from the stack.

Bottom surfaces 710 of the trays 700 are each configured to mate with an associated top surface 810 of the containment lids 800. For instance, in the example shown, the bottom surface 710 of tray 700b is configured to mate with the top surface 810 of the containment lid 800. Accordingly, the bottom and top surfaces comprise substantially equal surface areas and are oriented in parallel with respect to the x-y plane. In some embodiments, the bottom surface may comprise grooves 711 oriented in parallel with respect to the x-axis for receiving corresponding slots 811 disposed upon the top surface 810 of the compartment lid 800. In other embodiments, the bottom surface 710 includes slots for receiving corresponding grooves disposed upon the top surface 810. The groove and slot pairs may assist in aligning the trays over top the compartment lids 800 and in securing engagement between the bottom and top surfaces.

The containment lids 800 each include front and back faces 814, 816, respectively, oriented in parallel with respect to the y-z plane to define widths W₁ and W₂ while inner and outer side faces 818, 819, respectively, are oriented in parallel with respect to the x-z plane to define the length L₁. Each lid includes the top surface 810 and a bottom perimeter surface 840 oriented in parallel with respect to the x-y plane and separated by a height H3 corresponding to the height of the front and back faces 814, 816, respectively. The bottom perimeter surface 840 is defined by the width W₁ extending between the outer side faces 819. The top surface 810 is defined by the width W₂ extending between the inner side faces 818. Fork guide surfaces 820 oriented perpendicular to and extending away from the inner side faces 818 to the outer side faces 819 are configured to guide the forks from the forklift when stacking or removing trays 700 from above. In the example shown in FIG. 5B, the fork guide surfaces 820 and the top surface 810 are separated by a height H₄. In some implementations, the fork guide surfaces 820 are opposed to associated ones of the fork support surfaces 713 to define the pair of fork slots 706.

As mentioned above, each lid 800 is configured to cover the battery modules stored within the receiving area 702 (e.g., receiving compartment 804) of the associated tray underneath. Each lid covers the top surface of the battery modules. In some embodiments, each lid 800 encloses the battery module sides. The bottom perimeter surface 840 of the lid 800 rests upon the top surface 712 of the tray 700 underneath. The lid 800 further includes a hollowed portion inward from the bottom perimeter surface 840 for accepting the height of the battery modules 100 stored within the receiving compartments 704 of the tray 700 underneath. For example, the lid 800 may be hollowed by a depth extending perpendicularly from the bottom perimeter surface 840. Thus, the hollowed portion of the lid 800 encloses portions of the battery module 100 sides that extend beyond the depth of the receiving area 702 of the associated tray 700 underneath.

Referring to FIG. 5B, the receiving area 702 is formed in the top surface 712 of the tray 700 and is defined by a receiving front wall 724, a receiving back wall 726 and receiving side walls 728. The receiving front and back walls 724, 726, respectively, are oriented in parallel with respect to the y-z plane while the receiving sidewalls 728 are oriented in parallel with respect to the x-z plane. The receiving area 702 includes a receiving surface 720 parallel to the x-y plane. A distance between the receiving surface 720 and the top surface 712 defines a height of the walls 724, 726, 728 and denotes a depth of the receiving area 702. In some examples, the receiving area depth is selected based on the height of the battery modules being received therein. For example, the receiving area depth may be substantially the same as or slightly greater than the height of the battery modules being received therein. The receiving surface 720 is configured to support the battery modules received by the receiving area 702.

In some embodiments, a plurality of ribs 722, 723 protrude from the receiving surface 720 to provide a spacer between resting surfaces of the battery modules and the receiving surface 720. For example, if one of the battery modules leaks electrolyte, the leaked electrolyte may be contained along the receiving surface 720 without contacting the resting surface of other battery modules within the receiving area. The ribs 722, 723 may be arranged in uniformly spaced rows across the receiving surface 720. In some implementations, the ribs 722 are arranged in uniformly spaced rows each oriented in parallel with respect to the x-axis. In some examples, the ribs 722 may be arranged in two sets of uniformly spaced rows. In the example shown, a first set of ribs 722 may include rows oriented in parallel with respect to the x-axis while a second set of ribs 723 may include rows oriented in parallel with respect to the y-axis.

In some examples, one or more divider walls 730 are disposed within the receiving area 702. The divider walls 730 may be oriented in parallel with respect to the x-axis and extend between the front and back walls 724, 726, respectively. The divider walls 730 include a height associated with the receiving area 702 depth, i.e., the distance between the receiving surface 720 and the top surface 712. The divider walls 730 are configured to divide the receiving area 702 into substantially equally spaced rows each having a uniform width with respect to the y-axis. In the example shown, one divider wall 730 is disposed within the receiving area 702 to divide the receiving area into two substantially equally spaced rows. For example, the divider wall 730 is parallel to and spaced halfway between the sidewalls 328. However, other examples can include two divider walls that divide the receiving area into three equally spaced rows, three divider walls that divide the receiving area into four equally spaced rows and so on.

Additionally, the receiving area 702 includes dividers 732 disposed therein. The dividers 732 may be oriented in parallel with respect to the y-axis and extend between the sidewalls 728. The dividers 732 include a height associated with the divider walls 730 and the receiving area 702 depth. The dividers 732 are configured to divide the receiving area 702 into substantially equally spaced columns having a uniform length with respect to the x-axis. In the example shown, one set of four dividers 732 oriented longitudinally with respect to the y-axis divide the receiving area 702 into two substantially equally spaced columns. In the example shown, the dividers 732 are parallel to and spaced halfway between the front and back walls 724, 726, respectively. However, other examples can include two sets of dividers 732 each oriented parallel to each other that divide the receiving area 702 into three equally spaced columns, three sets of four dividers 732 each oriented parallel to one another that divide the receiving area 702 into four equally spaced columns and so on.

In the example shown, a pair of dividers 732 is disposed within the first row on one side of the divider wall 730 while another pair of dividers 732 is disposed within the second row on the other side of the divider wall 730. Each divider 732 includes a first contact surface parallel to and facing the front wall 724 and a second contact surface parallel to and facing the back wall 726. The first contact surfaces are associated with a first column of the receiving area 702 while the second contact surfaces are associated with a second column of the receiving area 702. The first contact surfaces of the pair of dividers 732 disposed within the first row are configured to contact a surface of a first battery module received within the first column of the first row between the divider wall 730, the back wall 726, and the side wall 728 adjacent to the first row of the receiving area 702. The second contact surfaces of the pair of dividers 732 disposed within the first row are configured to contact a surface of a second battery module received within the second column of the first row between the divider wall 730, the front wall 724, and the side wall 728 adjacent to the first row of the receiving area 702.

Similarly, the first contact surfaces of the pair of dividers 732 disposed within the second row are configured to contact a surface of a third battery module received within the first column of the second row between the divider wall 730, the back wall 726, and the side wall 728 adjacent to the second row of the receiving area 702. The second contact surfaces of the pair of dividers 732 disposed within the second row are configured to contact a surface of a fourth battery module received within the second column of the second row between the divider wall 730, the front wall 724, and the side wall 728 adjacent to the second row of the receiving area 702.

Accordingly, the dividers 732 and the one or more divider walls 730 are configured to segment each of the receiving compartments 704 of the receiving area 702. In some implementations, spacers 734, 736, 738 are provided to prevent surfaces of the battery modules within each of the receiving compartments 704 from contacting the front, back, side, and/or divider walls 724, 726, 728, 730, respectively. For example, the divider wall 730 includes a plurality of divider wall spacers 734 protruding outward from the divider wall 730 toward the sidewalls 728 with respect to the x-y plane. Each divider wall spacer 734 includes a contact surface for contacting surfaces of the battery modules adjacent to the divider wall 730. Similarly, the sidewalls 728 include a plurality of sidewall spacers 738 that protrude inward from the sidewalls 728 toward the divider wall 726 with respect to the x-y plane. Each sidewall spacer 738 includes a contact surface for contacting surfaces of the battery modules adjacent to the sidewalls 728. The front and back walls 724, 726, respectively, include a plurality of front-back wall spacers 736 protruding inward from the walls 724 or 726 toward the dividers 732 with respect to the x-y plane. Each front-back wall spacer 736 includes a contact surface for contacting surfaces of the battery modules 100 adjacent to the front wall 724 or the back wall 726.

FIG. 6A is an exploded view of another example containment system 900 for battery modules 100. The containment system comprises one or more containment trays 1000a-1000b each configured to store one or more battery modules within a receiving area 1002. The receiving area may be divided into receiving compartments 1004, wherein each receiving compartment is configured to receive a battery module. In the example shown, each receiving area is divided into four receiving compartments 1004 for receiving four battery modules. The containment system further comprises one or more lids 1000′ each configured to at least substantially cover battery modules stored within the receiving area 1002 of each associated tray underneath and support each associated tray above. Accordingly, the containment trays and lids are stacked in an alternating repeating pattern and oriented in parallel with respect to the z-axis to define a height of the containment system, wherein a bottom surface 1010 of the bottom tray 1000a storing battery modules 100 is supported above the ground surface by support members 1006, 1008 while the top tray 1000b storing battery modules includes support members 1006, 1008 that cooperate with support members 1006′, 1008′ of the lid 1000′ to support the bottom surface of the top tray 1000b above the lid underneath. More lids and trays can be stacked in the alternating repeated pattern above the top tray 1000b shown in FIG. 6A.

Front and back faces 1014, 1016 of the trays 1000 are oriented in parallel with respect to the y-z plane to define a width W of the trays while side faces 1018, 1018′ are oriented in parallel with respect to the x-z plane to define a length L of the trays. Each tray includes top inward edge surfaces 1011, 1011′, top outward edge surfaces 1012 and a bottom surface 1010 oriented in parallel with respect to the x-y plane, wherein the top inward and outward edge surfaces 1011, 1012 are substantially coplanar and separated from the bottom surface 1010 by a height H₁ corresponding to the height of the front, back and side faces. The top inward and outward edge surfaces 1011, 1012 form a continuous top surface 1011, 1012 for the trays 1000 that defines an opening into the receiving areas 1002.

A recessed front portion 1015 formed in a portion of the front face 1014 along the top inward edge surface 1011 and oriented in parallel with the x-z plane converges with a first recessed side portion 1019 formed in a portion of one of the side faces 1018 along the top inward edge surface and oriented in parallel with the y-z plane to partially define one of the receiving compartments 1004. A ledge 1013 disposed between the top inward edge surface 1011 and the bottom surface 1010 of each tray 1000 and oriented in parallel with respect to the x-y plane extends outward from the recessed front portion 1015 and the first recessed side portion 1019 to interconnect with corresponding portions of the front face 1014 and the side face 1018. The ledge 1013 defines a height H₂ that less than the height H₁ defined by the distance between the bottom surface 1010 and the top surface 1011, 1012.

Similarly, a recessed back portion 1017 formed in a portion of the back face 1016 along the other top inward edge surface 1011 and oriented in parallel with the x-z plane converges with a second recessed side portion 1021 formed in a portion of the other side face 1018 along the top inward edge surface and oriented in parallel with the y-z plane to partially define another one of the receiving compartments 1004 not adjacent to the receiving compartment 1004 defined by the recessed front portion 1015 and the first recessed side portion 1019. Another ledge 1013 defined by the height H₂ also extends outward from the recessed back portion 1017 and the second recessed side portion 1021 to interconnect with corresponding portions of the back face 1016 and the other side face 1018.

In some embodiments, one or more of the faces 1014, 1016, 1018 define one or more slots 1090, 1092 that protrude into the receiving area 1002. In some embodiments, the slots are defined by tapered slot sidewalls that partially extend into the receiving area 1002 and terminate at a slot wall 1091, 1093 perpendicular to the x-y plane to define a slot depth. The slots 1090 are defined by portions of the faces 1014, 1016, 1018 not including the corresponding recessed portions 1015, 1017, 1019, 1021 and extend between the bottom surface 1010 and the top outward edge surface 1012 such that the slot wall 1091 is defined. The slots 1092 are defined by the associated ones of the recessed portions 1015, 1017, 1019, 1021 and corresponding portions of the faces 1014, 1016, 1018 such that a uniform slot wall 1093 is defined. While the slots 1090 include a slot cover 1095 extending substantially parallel to the top outward edge surface 1012 of the trays 1000, the ledges 1013 interconnecting the recessed portions 1015, 1017, 1019, 1021 and the corresponding portions of the faces 1014, 1016, 1016 extend through the slots 1091.

FIG. 6A shows the receiving area 1002 defined by a receiving front wall 1024, a receiving back wall 1026, and receiving side walls 1028. The receiving front and back walls 1024, 1026, respectively, are oriented in parallel with respect to the y-z plane while the receiving sidewalls 1024 are oriented in parallel with respect to the x-z plane. The receiving area 1002 includes a receiving surface 1020 oriented in parallel with respect to the x-y plane and disposed on an opposite side of the tray 1000 than the bottom surface 1010. A distance between the receiving surface 1020 and the top surface 1011, 1012 defines a height of the walls 1024, 1026, 1028 and denotes a depth of the receiving area 1002. In some examples, the receiving area depth is selected based on the height of the battery modules being received therein. For example, the receiving area depth may be substantially the same as or slightly less than the height of the battery modules being received therein. The receiving surface 1020 is configured to support the battery modules received by the receiving area 1002.

Referring to FIG. 6B, in some embodiments, a top view of the containment tray 1000 shows plurality of ribs 1022, 1023 that protrude from the receiving surface 1020 to provide a spacer between resting surfaces of the battery modules and the receiving surface 1020. For example, if one of the battery modules leaks electrolyte, the leaked electrolyte may be contained along the receiving surface 1020 without contacting the resting surface of other battery modules within the receiving area. The ribs 1022, 1023 may be arranged in uniformly spaced rows across the receiving surface 1020. In some implementations, the ribs 1022 are arranged in uniformly spaced rows each oriented in parallel with respect to the x-axis. In some examples, the ribs 1022 may be arranged in two sets of uniformly spaced rows. In the example shown, a first set of ribs 1022 may include rows oriented in parallel with respect to the x-axis while a second set of ribs 1023 may include rows oriented in parallel with respect to the y-axis.

Referring to FIGS. 6A and 6B, a first conduit member 1080 extends into the receiving area 1002 from the receiving surface 1020 in a direction substantially parallel to the z-axis and defines a first conduit passage 1082 that extends through the receiving surface 1020 and the bottom surface 1010 of the tray 1000. A first distance D₁ extending along the x-axis is defined between the first conduit member 1080 and each of the receiving front and back walls 1024, 1026, respectively, while a second distance D₂ extending along the y-axis and less than the first distance D₁ is defined between the first conduit member 1080 and each of the receiving sidewalls 1028. The first conduit member 1080 may include a height less than a height of the walls 1024, 1026, 1028.

With continued reference to FIGS. 6A-6G, in some embodiments, one or more divider walls 1030, 1030′ are disposed within the receiving area 1002 that extend from the first conduit member 1080, 1080′ to a corresponding one of the receiving front, back or sidewalls 1024, 1026, 1028. For example, two substantially collinear divider walls 1030, 1030′ each defining a length substantially equal to the first distance D₁ may be oriented in parallel with respect to the y-axis and two substantially collinear divider walls 1030 each defining a length substantially equal to the second distance D₂ may be oriented in parallel with respect to the x-axis. The divider walls 1030 include a height substantially equal to the height of the first conduit member 1080 and less than a height of the receiving walls 1024, 1026, 1028, i.e., the distance between the receiving surface 1020 and the top surface 1011, 1012. The divider walls 1030 are configured to divide the receiving area 1002 into substantially equally spaced rows and columns, wherein each row has a uniform width with respect to the x-axis and each column has a uniform length with respect to the y-axis. For example, two of the collinear divider walls 1030 are parallel to and spaced halfway between the receiving sidewalls 1028 and the other two collinear divider walls 1030 are parallel to and spaced halfway between the receiving front and back walls 1024, 1026, respectively. However, other examples can include additional divider walls to divide the receiving area into three equally spaced rows and/or columns, four equally spaced rows and/or columns and so on.

Additionally, the receiving area 1002 includes divider wall spacers 1032 disposed therein. In the example shown, divider wall spacers 1032 extend parallel and adjacent to each side of the divider walls 1030. For example, the divider walls 1030 include a divider wall spacer 1032 disposed along each side thereof, and each divider wall spacer includes a height less than the height of the divider walls 1030. A groove 1033, 1035 formed in the bottom surface 1010 of the tray 1000 that extending into the receiving area 1002 may define the divider wall spacers 1032 such that each divider wall spacer 1032 includes a contact surface parallel to and facing one of the receiving front wall 1024, the receiving back wall 1026, or one of the receiving sidewalls 1028. Accordingly, each row-column pair (e.g., receiving compartment 1004) of the receiving area 1002 includes a pair of divider wall spacers 1032 perpendicular to one another so that one divider wall spacer 1032 of the pair has a contact surface parallel to and facing one of the receiving front wall 1024 or the receiving back wall 1026 and the other divider wall spacer 1032 of the pair has a contact surface parallel to and facing one of the receiving sidewalls 1028. The contact surfaces of each perpendicular pair of divider wall spacers 1032 are each configured to contact at least a portion of an opposing surface of a battery module received within the associated row-column pair of the receiving area 1002. Accordingly, the divider wall 1030 and the divider wall spacers 1032 are configured to segment each of the receiving compartments 1004 of the receiving area 1002.

In some embodiments, spacers 1034, 1036 are provided to prevent surfaces of the battery modules within each of the receiving compartments 1004 from contacting the front, back, and/or sidewalls 1024, 1026, 1028, respectively. For example, the receiving front and back walls 1024, 1026, respectively, each include a plurality of front-back wall spacers 1034 protruding inward from the associated one of the receiving front wall 1024 or the receiving back wall 1026 toward the other one of the receiving front wall 1024 or the receiving back wall 1026 with respect to the x-y plane. FIGS. 6A and 6B show each of the slot walls 1091, 1093 associated with the receiving front and back walls 1024, 1026, respectively, extending into the receiving area 1002 and including a pair of the front-back wall spacers 1034. For instance, each front-back wall spacer 1034 protrudes into the receiving area 1002 and includes a contact surface configured to contact at least a portion of an opposing surface of the battery module disposed within the associated receiving compartment 1004. Similarly, the receiving sidewalls 1028 each include a plurality of receiving sidewall spacers 1036 protruding inward from the associated one of the receiving sidewalls toward the other one of the receiving sidewalls 1028 with respect to the x-y plane. For instance, each of the slot walls 1091, 1093 associated with the receiving sidewalls 1028 extend into the receiving area 1002 and include a pair of the receiving sidewall spacers 1036. Each receiving sidewall spacer 1036 protrudes into the receiving area 1002 and includes a contact surface configured to contact at least a portion of an opposing surface of the battery module disposed within the associated receiving compartment 1004. In some embodiments, the sidewall spacers 1036 protrude further into the receiving area 1002 than the front-back wall spacers 1034. Accordingly, the battery modules 100 disposed within the receiving compartments each include one surface facing and in contact with contact surfaces of a pair of front-back wall spacers 1034, a second surface facing and in contact with contact surfaces of a pair of sidewall spacers 1036, a third surface facing and in contact with a contact surface of one of the divider wall spacers 1032, a fourth surface facing and in contact with a contact surface of another one of the divider wall spacers 1032, a bottom surface facing the receiving surface 1020 and in contact with the ribs 1022, 1023 protruding from the receiving surface, and a top surface enclosed by the containment lid 1000′ stacked overtop.

Each lid 1000′ comprises a containment tray 1000 rotated 180° about the y-axis. In view of the substantial similarity in structure and function of the components associated with the containment trays 1000 with respect to the lids 1000′, like numerals are used hereinafter and in the drawings to identify like components. The top outward edge surfaces 1012 and the ledges 1013 of each tray 1000 are configured to support the associated containment lid 1000′ stacked vertically above. For instance, in the example shown, the top outward edge surfaces 1012 of tray 1000a are configured to align and mate with the associated ledges 1013′ of the containment lid 1000′, while the ledges 1013 of tray 1000a are configured to align and mate with the associated top outward edge surfaces 1012′ of the containment lid 1000′. In some embodiments, the battery modules 100 received within the receiving compartments 1004 include a height greater than the receiving area depth, and therefore a portion of the battery modules are exposed from the top inward and outward edge surfaces 1011, 1012 of the tray 1000. When the lid 1000′ is supported by the tray 1000a, the receiving area 1002′ of the lid 1000′ may accommodate the exposed portions of the battery modules received by the receiving compartments 1004 of the tray 1000a. Accordingly, each lid covers the top surface of the battery modules stored within the receiving compartments 1004 of the tray 1000 underneath and may enclose a portion of the battery module sides that extend beyond the depth of the receiving area 1002 of the associated tray 1000 underneath. One or more of the slot covers 1095 and ledges 1013 of the tray 1000 may include apertures 1094 that align with corresponding apertures 1094′ formed through slot covers 1092′ and ledges 1013′ of the containment lid 1000′ stacked overtop such that fasteners may pass through the aligned apertures 1094, 1094′ to secure the lid to the tray.

Referring to FIG. 6C, a side view of the containment tray 1000 shows a second conduit member 1084 extending from the bottom surface 1010 of the tray in a direction substantially parallel to the z-axis and defining a second conduit passage 1086 that aligns with the first conduit passage 1082 defined by the first conduit member 1080. The second conduit member 1084 may be disposed within a region of the bottom surface 1010 of the trays 1000 where the grooves 1033, 1035 (FIG. 6A) formed therein intersect. Similarly, FIG. 6D shows a side view of the containment lid 1000′ including a second conduit member 1084′ extending from the bottom surface 1010′ of the lid in a direction substantially parallel to the z-axis and defining a second conduit passage 1086′. The second conduit member 1084′ may be disposed within a region of the bottom surface 1010′ of the lid 1000′ where grooves 1033′, 1035′ (FIG. 6A) formed therein intersect. Referring to FIG. 6A, the second conduit member 1084′ of the containment lid 1000′ is configured to mate with the second conduit member 1084 of the containment tray 1000b such that the second conduit passages 1086, 1086′ are aligned and interface with each other when the tray 1000b is stacked above the bottom surface 1010′ of the lid 1000′. While the second conduit member 1084 of the tray 1000b is configured to mate with the opposing first conduit member 1080 of the lid 1000′ underneath, the first conduit member 1080 of the tray 1000b is not configured to mate with an opposing first conduit member associated with a containment lid (not shown) stacked above. Instead, the opposing first conduit members of each tray-lid pair are separated by a gap 1099 (FIGS. 6F and 6G) operative to permit wiring 1098 (FIGS. 6F and 6G) extending through the conduit passages 1082, 1082′, 1084, 1084′ to electrically connect with terminals of the battery modules 100 stored in the receiving compartments 1004 of the associated tray 1000b.

Referring to FIGS. 6A-6D, each tray 1000 includes a plurality of support members 1006, 1008 that extend through the bottom surface 1010 and the receiving surface 1020. The trays may include two non-adjacent support members 1006 and two non-adjacent support members 1008 each associated with a surface area that is smaller than a surface area associated with each of the two other support members 1006. Each support member 1006, 1008 extends substantially parallel to the z-axis and includes a first portion extending in a first direction away from the bottom surface 1010 to support the trays 1000 above the ground surface or the lid 1000′ underneath and a second portion extending in an opposite second direction away from the receiving surface 1020 to support the lid 1000′ stacked overtop.

Likewise, each lid 1000′ includes a plurality of support members 1006′, 1008′ that extend through the bottom surface 1010′ and the receiving surface 1020′. The lids may include two non-adjacent support members 1006′ and two non-adjacent support members 1008′ each associated with a surface area that is smaller than a surface area associated with each of the two other support members 1006. In some examples, the surface area of the support members 1006′ of the lids 1000′ is the same as the surface area of the support members 1006 of the trays 1000, and the surface area of the support members 1008′ of the lids 1000′ is the same as the surface area of the support members 1008 of the trays 1000. Each support member 1006′, 1008′ extends substantially parallel to the z-axis and includes a first portion extending in the second direction away from the bottom surface 1010′ to receive and support the tray 1000 above (e.g., tray 1000b in FIG. 6A) and a second portion extending in the opposite first direction away from the receiving surface 1020′ to support the lid 1000′ above the tray underneath (e.g., tray 1000a in FIG. 6A).

In some embodiments, the second portion of each support member 1006′, 1008′ of the lids 1000′ is configured to partially extend into the receiving area 1002 of the tray underneath and mate with an aligned one of the support members 1006, 1008 of the tray underneath. In some embodiments, the second portion of each support member 1006′ of the lid 1000′ mates with an aligned one of the second portion of each support member 1008 of the tray 1000 underneath. For example, when the top outward edge surfaces 1012 of tray 1000a align and mate with the associated ledges 1013′ of the lid 1000′ and the ledges 1013 of the tray 1000a align and mate with the associated top outward edge surfaces 1012′ of the lid 1000′, the second portion of the support members 1006′ of the lid 1000′ align and mate with the second portion of the support members 1008 of the tray 1000a and the second portion of the support members 1008′ of the lid 1000′ align and mate with the second portion of the support members 1006 of the tray 1000a. The first portion of each support member 1006, 1008 of the bottom tray 1000a is configured to mate with the ground surface such that the tray 1000a is supported above the ground surface.

In some embodiments, the first portion of each support member 1006′, 1008′ of the lids 1000′ is configured to mate with an aligned one of the support members 1006, 1008 of the tray stacked above. In some configurations, the first portion of each support member 1006′ of the lid 1000′ mates with an aligned one of the first portion of each support member 1008 of the tray 1000 stacked above. For instance, with reference to the example shown in FIG. 6A, the first portion of the support members 1006′ of the lid 1000′ align and mate with the first portion of the support members 1008 of the top tray 1000b and the first portion of the support members 1008′ of the lid 1000′ align and mate with the first portion of the support members 1006 of the tray 1000b. Accordingly, the mating between the first portion of the support members 1006, 1008 of the tray 1000b and the first portion of the support members 1006′, 1008′ of the lid 1000′ is operative to support the tray 1000b above the lid 1000′ such that the opposing bottom surfaces 1010, 1010′ are spaced apart by a separation distance SD (FIGS. 6F and 6G).

Referring to FIG. 6A, the bottom surface 1010′ of the lid 1000′ includes the grooves 1033′, 1035′ formed therein, the second conduit member 1084′ disposed within the region where the grooves 1033′, 1035′ intersect to define the second conduit passage 1086′, and the first portion of the support members 1006′, 1008′ extending away from the bottom surface 1010′ in a direction parallel to the z-axis. A plurality of brackets 1050′, 1051′, 1052′, 1053′ extend from the bottom surface 1010′ in a direction parallel to the z-axis to define a height substantially equal to a distance the first portion of the support members 1006′, 1008′ extend from the bottom surface 1010′. Each bracket 1050′-1053′ includes a base portion extending substantially parallel to the x-axis and a pair of arms each extending from an opposite end of the base in a direction substantially parallel to the y-axis. A first bracket 1050′ has a base extending adjacent to a side of the groove 1035′ opposing the front face 1014′ and a pair of arms extending from the base toward the front face 1014′ of the lid 1000′. A second bracket 1051′ includes a base extending on a side of the groove 1035′ opposing the back face 1016′ and a pair of arms extending from the base toward the front face 1014′. A third bracket 1052′ has a base extending adjacent to the side of the groove 1035′ opposing the back face 1016′ on an opposite side of the groove 1033′ than the second bracket 1051′ and a pair of arms extending from the base toward the back face 1016′ of the lid 1000′. A fourth bracket 1053′ includes a base extending on a side of the groove 1035′ opposing the front face 1014′ on an opposite side of the groove 1033′ than the first bracket 1050′ and a pair of arms extending from the base toward the back face 1016′ of the lid 1000′. The bases of the first and third brackets 1050′, 1052′ may define an equal length, and the bases of the second and fourth brackets 1051′, 1053′ may define an equal length shorter than the length of the first and third brackets 1050′, 1052′. The brackets 1050′-1053′ are configured to contact the bottom surface 1010 of the tray 1000 stacked above.

Referring to FIG. 6E, a bottom view of a containment tray 1000 shows the grooves 1033, 1035 formed therein, the second conduit member 1084 disposed within the region where the grooves 1033, 1035 intersect to define the second conduit passage 1086, and the first portion of the support members 1006, 1008 extending away from the bottom surface 1010 in a direction parallel to the z-axis. The containment tray 1000 in the example shown may correspond to a bottom containment tray supporting a plurality of vertically-stacked tray-lid pairs, as shown in the cross-sectional views of FIGS. 6F and 6G. A plurality of brackets 1050, 1051, 1052, 1053 extend from the bottom surface 1010 in a direction parallel to the z-axis to define a height substantially equal to a distance the first portion of the support members 1006, 1008 extend from the bottom surface 1010. The brackets 1050, 1051, 1052, 1053 of the tray 1000 are substantially identical to corresponding ones of the brackets 1050′, 1051′, 1052′, 1053′ of the lid 1000′ discussed above, wherein like reference numerals indicate like features. The brackets 1050-1053 are configured to contact the bottom surface 1010′ of the lid 1000′ underneath.

Referring to FIGS. 6A and 6E, in some embodiments, the brackets 1050′-1053′ of the lid 1000′ are configured to interlock with aligned ones of the brackets 1050-1053 of the tray 1000 to prevent shifting of the tray stacked above. For instance, the first bracket 1050′ of the lid 1000′ encloses at least a portion of the aligned fourth bracket 1053 of the tray 1000b stacked above, the second bracket 1051′ of the lid is enclosed by at least a portion of the aligned third bracket 1052 of the tray, the third bracket 1052′ of the lid encloses at least a portion of the aligned second bracket 1051 of the tray, and the fourth bracket 1053′ of the lid is enclosed by at least a portion of the aligned first bracket 1050 of the tray. This interaction between the brackets 1050′-1053′ of the lid 1000′ and aligned ones of the brackets 1050′-1053′ of the tray 1000b stacked above allows the arms to interlock, and thereby prevent shifting between the lid 1000′ and the tray 1000b supported above.

Referring to FIGS. 6F and 6G, a cross-sectional view taken along line 6F-6F (FIG. 6F) and a cross-sectional view taken along line 6G-6G (FIG. 6G) show the containment system 900 including a plurality of containment trays 1000 and containment lids 1000′ stacked in an alternating repeating pattern. For instance, the plurality of containment lids 1000′ are each oriented parallel to the plurality of containment trays 1000 and configured to cover the battery modules 100 within the receiving areas 1002 of the containment trays. Electrical wiring 1098 extends through the conduit passages 1082, 1082′, 1086, 1086′ defined by associated ones of the first conduit member 1080, 1080′ and the second conduit member 1086, 1086′. The gap 1099 between the opposing first conduit members 1080, 1080′ of each tray-lid pair provides a passage for the wiring 1098 to connect with terminals of the battery modules 100 stored within the receiving areas 1002 of each tray 1000. The battery modules 100 contained by the trays 1000 may be electrically connected in series or in parallel. As mentioned above, the second conduit member 1084 of each tray 1000 aligns and mates with the second conduit member 1086 associated with the lid 1000′ underneath such that the electrical wiring 1098 may extend through the conduit passages 1082, 1082′, 1086, 1086′ and pass through the next gap 1099 to connect with the terminals of the battery modules 100 stored within the receiving area 1002 of the tray 1000 above. Moreover, the first portions of the support members 1006, 1006′, 1008, 1008′ and the brackets 1050′, 1051′, 1052′, 1053′ cooperate to provide the separation distance SD between each lid 1000′ and the associated tray 1000 supported above. The separation distance SD permits air to flow underneath the receiving areas 1002 of each tray 1000 to provide cooling for the battery modules 100 stored therein.

### Other Embodiments

A number of embodiments and examples have been described herein. Nevertheless, it will be understood that various modifications may be made without departing from the spirit and scope of the invention. Accordingly, other implementations are within the scope of the following claims.

What is claimed is:

1. An apparatus for storing one or more battery modules (100) comprising a containment tray (300, 500, 700, 1000) defined by opposing front and back faces (314, 316, 714, 716, 1014, 1016), opposing side faces (318, 718, 1018), and opposing top and bottom surfaces (310, 312, 522, 532, 710, 712, 1010, 1011, 1012) oriented perpendicular to the front, back, and side faces (318, 718, 1018), wherein the containment tray (300, 500, 700, 1000) has a receiving area (302, 518, 702, 1002) formed in the top surface (302, 312, 712, 1011, 1012) for receiving one or more battery modules (100), the receiving area (302, 518, 702, 1002) comprising a receiving surface (320, 520, 720, 1020) oriented parallel to and located between the opposing top and bottom surfaces (310, 312, 522, 532, 710, 712, 1010, 1011, 1012) for supporting the one or more battery modules (100).

2. The apparatus of claim 2, wherein the front and back faces (314, 316, 714, 716, 1014, 1016) are oriented in parallel and separated by a distance that defines a width of the containment tray (300, 500, 700, 1000), the side faces (318, 718, 1018) are oriented perpendicular to the front and back faces (314, 316, 714, 716, 1014, 1016) and separated by a distance that defines a length of the containment tray (300, 500, 700, 1000), and the top and bottom surfaces (310, 312, 522, 532, 710, 712, 1010, 1011, 1012) are separated by a distance that defines a height of the containment tray (300, 500, 700, 1000).

3. The apparatus of claim 1 or 2, wherein the receiving area (302, 518, 702, 1002) is defined by:
a receiving front wall (324, 524, 724, 1024) oriented parallel to and inward from the front face (314, 714, 1014);
a receiving back wall (326, 526, 726, 1026) oriented parallel to and inward from the back face (316, 716, 1016), the receiving front wall (324, 524, 724, 1024) and back wall (326, 526, 726, 1026) separated by a distance to define a length of the receiving area (302, 518, 702, 1002);
a pair of receiving side walls (328, 528, 728, 1028) oriented parallel to and inward from associated ones of the side faces (318, 718, 1018), the pair of receiving side walls (328, 528, 728, 1028) separated by a distance to define a width of the receiving area (302, 518, 702, 1002); and
the receiving surface (320, 520, 720, 1020) oriented perpendicular to the receiving front wall (324, 524, 724, 1024), the receiving back wall (326, 526, 726, 1026), and the pair of receiving sidewalls (328, 528, 728, 1028), the receiving surface (320, 520, 720, 1020) separated from the top surface (302, 312, 712, 1011, 1012) by a distance to define a depth of the receiving area (302, 518, 702, 1002).

4. The apparatus of claim 3, wherein the depth of the receiving area (302, 518, 702, 1002) is greater than a height of the one or more battery modules (100).

5. The apparatus of claim 3, wherein the depth of the receiving area (302, 518, 702, 1002) is substantially equal to a height of the one or more battery modules (100).

6. The apparatus of claim 3, wherein the depth of the receiving area (302, 518, 702, 1002) is less than a height of the one or more battery modules (100).

7. The apparatus of any one of claims 3 to 6, further comprising:
a plurality of side wall spacers (338, 738, 1036) that protrude inward from each of the pair of receiving side walls (328, 728, 1028), each side wall spacer (338, 738, 1036) comprising a side contact surface for contacting at least a first surface of the one or more battery modules (100) adjacent to the receiving side walls (328, 528, 728, 1028); and
a plurality of front-back wall spacers (336, 736, 1034) protruding inward from the receiving front wall (324, 524, 724, 1024) or the receiving back wall (326, 526, 726, 1026), each front-back wall spacer (336, 736, 1034) comprising a contact surface for contacting at least a second surface of the one or more battery modules (100) adjacent to the receiving front wall (324, 524, 724, 1024) or the receiving back wall (326, 526, 726, 1026).

8. The apparatus of any one of claims 3 to 7, further comprising one or more divider walls (330, 530, 730, 1030) disposed within the receiving area (302, 518, 702, 1002) and extending between the receiving front wall (324, 524, 724, 1024) and the receiving back wall (326, 526, 726, 1026), the one or more divider walls (330, 530, 730, 1030) oriented in parallel with respect to the receiving side walls (328, 528, 728, 1028) and configured to divide the receiving area (302, 518, 702, 1002) into substantially equally spaced rows each having a substantially uniform width.

9. The apparatus of claim 8, wherein one or more of the divider walls (1030) extend between the receiving sidewalls (1028), the divider walls (1030) oriented in parallel with respect to the front wall (1024) and the back wall (1026) and configured to divide the receiving area (1002) into substantially equally spaced columns each having a uniform length, wherein the one or more divider walls (1030) extending between the receiving sidewalls (1028) and the one or more divider walls extending between the front wall (1024) and the back wall (1026) are configured to segment the receiving area (1002) into a plurality of receiving compartments (1004) each separated from one another and configured to accommodate the one or more battery modules (100).

10. The apparatus of claim 8, further comprising one or more sets of dividers (332, 732) disposed within the receiving area (302, 702) and extending between the receiving side walls (328, 728), each set of dividers (332, 732) oriented in parallel with respect to the receiving front wall (324, 724) and the receiving back wall (326, 726) and configured to divide the receiving area (302, 702) into equally spaced columns each having a uniform width, wherein the sets of the dividers (332, 732) and the one or more divider walls (330, 730) are configured to segment the receiving area (302, 702) into a plurality of receiving compartments (304, 704) each separated from one another and configured to accommodate the one or more battery modules (100).

11. The apparatus of any one of claims 3-10, further comprising a plurality of divider wall spacers (334, 734, 1032) that protrude outward from one or more surfaces of the one or more divider walls (330, 730, 1030) toward the opposing receiving side walls (328, 728, 1028), each divider wall spacer (334, 734, 1032) comprising a surface for contacting one or more surfaces of the one or more battery modules (100) adjacent to the one or more divider walls (330, 730, 1030).

12. The apparatus of any one of claims 1-11, further comprising a plurality of ribs (322, 722, 723, 1022, 1023) protruding from the receiving surface (320, 720, 1020) to provide a spacer between the one or more battery modules (100) and the receiving surface (320, 720, 1020).

13. The apparatus of any one of claims 1-12, wherein the bottom surface (310, 532, 710) of the containment tray (300, 500, 1000) rests upon a ground surface.

14. The apparatus of any one of claim 1-5 or 7-12, wherein the containment tray (300, 700) is stacked upon a top surface (312, 712) of another containment tray (300, 700) and provides a cover for one or more battery modules (100) within the receiving area (302, 702) of the other containment tray (300, 700) underneath.

15. The apparatus of any one of claims 1-13, wherein a top surface (522) of the containment tray (500) is configured to support at least a portion of a lid (410, 1000′) for covering the one or more battery modules (100) within the receiving area (302, 518, 702, 1002).

16. The apparatus of any one of claims 1-15, wherein the containment tray (300, 500, 700, 1000) further comprises one or more openings extending through the front and back faces (314, 316, 714, 716, 1014, 1016) or one or more openings extending through opposing side faces (318, 718, 1018).

17. The apparatus of claim 16, wherein the openings are fork openings (306, 406, 706) configured to receive forks from a fork lift.

18. The apparatus of any one of claims 1-17, wherein the containment tray (300, 500, 700, 1000) further comprises one or more conduit terminals for connecting the one or more battery modules (100) to one another.

19. The apparatus of any one of claims 1-18, wherein the containment tray (300, 500, 700, 1000) further comprises one or more conduit terminals for connecting the one or more battery modules (100) to an electronic device.

20. The apparatus of any one of claims 1-19, wherein the containment tray (300, 500, 700, 1000) further comprises a flame retardant material.

21. The apparatus of claim 20, wherein the flame retardant material comprises at least one of high-density polyethylene or polypropylene.

22. A containment system (200, 400, 600, 900) comprising:
two or more containment trays (300, 500, 700, 1000) stacked in a parallel orientation to form a stack, each containment tray (300, 500, 700, 1000) comprising:
opposing front and back faces (314, 316, 714, 716, 1014, 1016), opposing side faces (318, 718, 1018), and opposing top and bottom surfaces (310, 312, 522, 532, 710, 712, 1010, 1011, 1012), wherein the opposing top and bottom surfaces (310, 312, 522, 532, 710, 712, 1010, 1011, 1012) are oriented perpendicular to the opposing front and back faces (314, 316, 714, 716, 1014, 1016) and the opposing side faces (318, 718, 1018); and
a receiving area (302, 518, 702, 1002) configured to receive one or more battery modules (100), the receiving area (302, 518, 702, 1002) comprising a receiving surface (320, 520, 720, 1020) oriented parallel to and located between the opposing top and bottom surfaces (310, 312, 522, 532, 710, 712, 1010, 1011, 1012) for supporting the one or more battery modules (100).

23. The containment system (200, 400, 600, 900) of claim 22, further comprising one or more containment lids (410, 800, 1000′) each oriented parallel to the two or more containment trays (300, 500, 700, 1000) and configured to cover the one or more battery modules (100) within the receiving areas of the containment trays (300, 500, 700, 1000), the containment lids (410, 800, 1000′) and the two or more containment trays (300, 500, 700, 1000) stacked in an alternating repeating pattern.

24. The containment system (200, 400, 600, 900) of claim 22 or 23, wherein at least one of the two or more containment trays (300, 500, 700, 1000) includes one or more openings.

25. The containment system (200, 400, 600, 900) of claim 24, wherein the one or more openings are slots for receiving forks from a forklift.

26. The containment system (200, 400, 600, 900) of any one of claims 22-25, further comprising a base (402) or support member (1006, 1008) resting upon a ground surface and configured to support the bottom surface (532, 1010) of the containment tray (500, 1000) at the bottom of the stack.

27. The containment system (200, 400, 600, 900) of any one of claims 21-26, further comprising one or more conduit terminals disposed at one or more of the containment trays (300, 500, 700, 1000) for connecting the one or more battery modules (100) to one another.

28. The containment system (200, 400, 600, 900) of any one of claims 21-27, further comprising one or more conduit terminals disposed at one or more of the containment trays (300, 500, 700, 1000) for connecting the one or more battery modules (100) to an electronic device.
